(19) United States
(12) Patent Application Publication
(10) Pub. No.: US 2019/0251787 A1
(43) Pub. Date: Aug. 15, 2019

(54) INTERACTIVE WAGERING PROCESS SYSTEM

(71) Applicant: Gamblit Gaming, LLC, Glendale, CA (US)

(72) Inventors: Bryce Cire, Pasadena, CA (US); Frank Cire, Pasadena, CA (US); Eric Metyerhofer, Pasadena, CA (US)

(21) Appl. No.: 16/149,065

(22) Filed: Oct. 1, 2018

Related U.S. Application Data
(60) Provisional application No. 62/566,486, filed on Oct. 1, 2017.
(60) Provisional application No. 62/595,557, filed on Dec. 6, 2017.

(51) Int. Cl. G07F 17/32

(52) U.S. Cl. CPC G07F 17/3244; G07F 17/3223; G07F 17/3206

(57) ABSTRACT

An interactive wagering process system is disclosed. The interactive wagering process system communicates with a credit input device to receive a credit input, credits a credit meter with credits based on the credit data, generates a random number using a random number generator, generates a stochastic element using the random number, and generates a virtual object in an interactive wagering game using the stochastic element. The interactive wagering process system detects player interactions of a player with the player presentation, determines if a player has interacted with the virtual object in a specified manner, detects an objective achievement based on the player interactions and the virtual object, updates the credit meter based on the objective achievement, and communicates with the credit output device to generate a credit output based on credits transferred off of the credit meter.

### CROSS REFERENCE TO RELATED APPLICATIONS

This application claims the benefit of U.S. Provisional Patent Application No. 62/566,486, filed Oct. 1, 2017, and U.S. Provisional Patent Application No. 62/595,557, filed Dec. 6, 2017, the contents of each of which are incorporated by reference herein.

### FIELD OF THE INVENTION

Embodiments of the invention are generally related to data processing systems. More particularly, embodiments of the invention relate to data processing systems that implement multivariate wagering processes.

### BACKGROUND

The gambling industry has traditionally developed simple gambling games having simple randomized features. The video gaming industry has traditionally developed complex video games that have few or no randomized features. In order to implement a gambling process for a complex video computer game, complex randomized features, as well as data processing systems capable of implementing these complex randomized features, are needed. Various aspects of embodiments of the invention meet such needs.

### SUMMARY OF THE INVENTION

Systems and methods in accordance with embodiments of the invention generate and process multivariate stochastic events within a context of an interactive application in order to implement an interactive wagering processes.

In an embodiment, an interactive process wagering electronic gaming machine includes an interactive controller constructed to receive from a process controller a stochastic element, generate a virtual object in an interactive wagering game using the stochastic element, detect player interactions of a player with the player presentation, determine if a player has interacted with the virtual object in a specified manner, detect an objective achievement based on the player interactions and the virtual object, and communicate the objective achievement to the wagering process controller. The process controller operatively connected to the interactive controller, wherein the wagering process controller is constructed to generate a random number using a random number generator, generate the stochastic element using the random number, communicate the stochastic element to the interactive controller, receive the objective achievement from the interactive controller, determine an award to award to the player based on the objective achievement.

In another embodiment, the interactive controller and the wagering process controller are constructed from the same device.

In yet another embodiment, the wagering process controller is operatively connected to the interactive controller using a communication link.

In yet another embodiment, a credit processing subcontroller and the wagering process controller are constructed from the same device.

In yet another embodiment, a credit processing subcontroller, the interactive controller, and the wagering process controller are constructed from the same device.

In yet another embodiment, the interactive process wagering electronic gaming machine further includes a credit processing subcontroller and an enclosure constructed to mount a user input device operatively connected to the interactive controller, a user output device operatively connected to the interactive controller, a credit input device operatively connected to the credit processing subcontroller, and a credit output device operatively connected to the credit processing subcontroller.

In yet another embodiment, the wagering process controller is further constructed to communicate with the credit input device to receive a credit input, credit a credit meter with credits based on the incoming credit data, update the credit meter based on the objective achievement of the wager, and communicate with the credit output device to generate a credit output based on credits transferred off of the credit meter.

In an embodiment, an interactive process wagering electronic gaming machine includes an enclosure constructed to mount a user input device, a user output device, a credit input device, a credit output device. The interactive process wagering electronic gaming machine further includes at least one processor operatively connected to the user input device, the user output device, the credit input device, and the credit output device and a memory operatively connected to the at least one processor. The memory stores processor executable instructions that when executed by the processor cause the processor to communicate with the credit input device to receive a credit input, credit a credit meter with credits based on the credit data, generate a random number using a random number generator, generate a stochastic element using the random number, generate a virtual object in an interactive wagering game using the stochastic element, detect player interactions of a player with the player presentation, determine if a player has interacted with the virtual object in a specified manner, detect an objective achievement based on the player interactions and the virtual object, update the credit meter based on the objective achievement, and communicate with the credit output device to generate a credit output based on credits transferred off of the credit meter.

In some embodiments, an interactive application is a skill-based game having interactive elements with which a player interacts in order to achieve objectives within a context of the interactive game and in accordance with the interactive wagering process.

In an embodiment, an interactive wagering process system includes an interactive controller that receives data of stochastic events in the form of stochastic elements for an interactive wagering process from a wagering process controller, generates a presentation having interactive elements based on the stochastic elements, presents the presentation to a player using a user interface, detects additional stochastic events in the form of player interactions of the player with the interactive elements, determines an objective achievement based on the player interactions and an objective, and communicates the objective achievement to the wagering process controller. The wagering process controller is operatively connected to the interactive controller, wherein the wagering process controller generates the stochastic elements of the interactive wagering process, communicates the stochastic elements to the interactive controller; and receives an objective achievement for the objective from the interactive controller.

In some embodiments, the interactive controller and the wagering process controller are constructed from the same device.

In various embodiments, the wagering process controller is operatively connected to the interactive controller using a communication link.

In numerous embodiments, an interactive wagering process system further includes a credit processing subcontroller, and an enclosure constructed to mount a user input device operatively connected to the interactive controller, a user output device operatively connected to the interactive controller, a credit input device operatively connected to the credit processing subcontroller, and a credit output device operatively connected to the credit processing subcontroller.

In some embodiments, the credit processing subcontroller is further constructed to communicate with the credit input device to receive a credit input, credit a credit meter with credits based on the incoming credit data, update the credit meter based on a wagering outcome determined from one or more objective achievements, and communicate with the credit output device to generate a credit output based on credits transferred off of the credit meter.

In another embodiment, a wagering process controller operates as an interface between an interactive controller that detects player interactions and a wagering subcontroller that generates stochastic elements of an interactive wagering process. By virtue of this feature, the wagering subcontroller is isolated from the interactive controller allowing the interactive controller to operate in an unregulated environment while allowing the wagering subcontroller to operate in a regulated environment, thus providing for more efficient management of the operations of such a system.

In another embodiment of the invention, a single wagering process controller may provide services to two or more interactive controllers, thus allowing an interactive wagering process system to operate more efficiently over a large range of scaling.

In another embodiment of the invention, multiple types of interactive controllers using different operating systems may be interfaced to a single type of wagering process controller without requiring customization of the wagering process controller and/or the wagering subcontroller, thus improving the efficiency of the wagering process controller and/or the wagering subcontroller by reducing complexity associated with maintaining separate wagering process controllers and/or wagering subcontrollers for each type of interactive controller.

In another embodiment of the invention, an interactive controller may be provided as a player device under control of a player while maintaining the wagering process controller in an environment under the control of a regulated operator of wagering systems.

In another embodiment of the invention, data communicated between the controllers may be encrypted to increase security of the interactive wagering process system.

In another embodiment of the invention, an interactive application may require extensive processing resources from an interactive controller leaving few processing resources for the functions performed by a wagering process controller and/or a wagering subcontroller. By virtue of an architecture of some embodiments of the invention, processing loads may be distributed across multiple devices such that operations of the interactive controller may be dedicated to an interactive application and the processes of the wagering process controller and/or wagering subcontroller are not burdened by the requirements of the interactive application.

In another embodiment of the invention, an interactive wagering process system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of an interactive wagering process system are distributed in close proximity to each other and communicate using a local area network and/or a communication bus. In several embodiments, an interactive controller and a wagering process controller of an interactive wagering process system are in a common location. In some embodiments, a wagering process controller communicates with an external interactive controller. In various embodiments, these multiple controllers and subcontrollers can be constructed from or configured using a single device or a plurality of devices such that an interactive wagering process system is executed as a system in a virtualized space such as, but not limited to, where a wagering subcontroller and a wagering process controller are large scale centralized servers and are operatively connected to distributed interactive controllers via a wide area network such as the Internet or a local area network. In such embodiments, the components of an interactive wagering process system may communicate using a networking protocol or other type of device-to-device communications protocol.

In another embodiment of the invention, an interactive controller is an interactive application server acting as a host for managing head-to-head player interactions over a network of interactive subcontrollers connected to the interactive server using a communication link. The interactive server provides a distributed environment where players can compete directly with one another and interact with other players.

### BRIEF DESCRIPTION OF THE DRAWINGS

FIG. 1 is a state diagram of an interactive wagering process system in accordance with various embodiments of the invention.

FIG. 2 is a diagram of a structure of an interactive wagering process system in accordance with various embodiments of the invention.

FIG. 3A is a diagram of an electronic gaming machine configuration of an interactive wagering process system in accordance with various embodiments of the invention.

FIG. 3B is a diagram of a table electronic gaming machine configuration of an interactive wagering process system in accordance with various embodiments of the invention.

FIG. 3C is a diagram of a virtual reality gaming machine configuration of an interactive wagering process system in accordance with various embodiments of the invention.

FIG. 4 is a diagram of distributed interactive wagering process systems in accordance with various embodiments of the invention.

FIGS. 5A and 5B are diagrams of a structure of an interactive controller of an interactive wagering process system in accordance with various embodiments of the invention.

FIG. 6 is a diagram of a structure of a wagering process controller of an interactive wagering process system in accordance with various embodiments of the invention.

FIG. 7 is an activity diagram of a process of an interactive wagering process system in accordance with various embodiments of the invention.

FIGS. 8A and 8B are sequence diagrams of interactions between components of an interactive wagering process system in accordance with various embodiments of the invention.

FIG. 9 is a state diagram illustrating a wagering process of an interactive wagering process system in accordance with various embodiments of the invention.

FIGS. 10A, 10B and 10C are illustrations of a user interface of an interactive wagering process system in accordance with various embodiments of the invention.

### DETAILED DESCRIPTION

A wagering game can be modeled using a multidimensional game space or manifold where each random element of the wagering game corresponds to a dimension of the manifold. The wagering game has multiple game states within the game space with a set of wager outcome game states being subset of all of the possible game states within the game space. An example embodiment of a simple wagering game is a mechanical 3 reel slot machine having 22 possible positions on each reel. Such a wagering game can be modeled within a three dimensional game space, that is, where each reel corresponds to a dimension of the three dimensional game space. If there are 22 possible unique values in each dimension, there are 22̂3, or 10,648, possible wager outcome game states. Each time the slot machine is played, a single wager outcome game state is determined from a single independent random event, namely the spinning of the mechanical reels.

If such a 3 reel slot machine is implemented on a conventional electronic gaming machine having virtual video reels, each possible wager outcome game state is explicitly enumerated in a paytable that is used to determine a wager outcome state as well as generate an animation of the video virtual reels. Such a paytable will have at least 10,648 locations, one position for each possible combination of the 3 reels, with each location representing a wager outcome game state including both a representation of the stopped position of the 3 reels and an amount of credit to be awarded a player of the wagering game. If digital storage of each wager outcome game state requires 8 bytes of storage, such a paytable can be stored in approximately 83 kilobytes of digital memory (8 bytes for wager outcome game state data×10,648 possible wager outcome game states/1024 Bytes per kilobyte). The digital memory may be either random access memory (RAM) of an internal memory device or virtual memory stored on an external memory device. In operation, a single random number is determined, and that random number is used as an index into the paytable to select a single wager outcome game state from the 10,648 possible wager outcome game states. The wager outcome game state is used to both determine a display of the animated movement of the 3 virtual slot machine reels and a prize in credits to be awarded to a player. Accordingly, approximately 83 kilobytes of memory is needed to store the enumerated wager outcome game states of a simple wagering game having approximately 10 thousand game states on a conventional electronic gaming machine.

In contrast to such simple wagering games, complex wagering games implemented with interactive wagering processes as described herein have sets of wager outcome game states that are many orders of magnitude larger than the sets of wager outcome game states of simple wagering games. In an example embodiment, a complex wagering game has a game feature where chance-based outcomes are displayed to a player as a subset of the possible wager outcome game states where the display includes 9 locations with each location having twenty-two possible chance-based outcomes. Such a complex wagering game feature has 1,207,269,217,792, or over 1.2 trillion, possible wager outcome game states. If 8 bytes of digital memory are used to store each wager outcome game state, then a complete enumeration of all of wager outcome game states would require 9.6 terabytes of memory storage. However, utilization of interactive wagering processes as described herein reduces storage memory requirements for such a complex wagering game feature to less than 1 kilobyte. Such a reduction in memory requirements reduces the amount of physical and/or virtual memory needed to implement the complex wagering game, and also may reduce an amount of time needed to generate a complex wagering game feature as described herein.

Furthermore, complex wagering games having interactive wagering processes as described herein have intermediate game states as well as wager outcome game states. In an example embodiment, a complex wagering game has a game space with 17 dimensions and approximately 1,576,418,005,371,090,000,000, or over 1.5 sextillion, possible game states. Enumeration and storage of such a set of game states for implementation of the complex wagering game on a conventional electronic gaming machine would require over 12.6 zettabytes of addressable memory storage. Such complex wagering games are simply not implementable using conventional electronic gaming machines. However, such complex wagering games may be implemented on various embodiments of an interactive wagering system as described herein.

An interactive wagering process system allows for the management of an interactive wagering process for one or more players where the interactive wagering process has one or more stochastic elements. In some embodiments of an interactive wagering process system, an interactive application executed by an interactive controller provides the interactive wagering process to the one or more players of the interactive wagering process system. The interactive controller is operatively connected to a wagering process controller that manages and configures the interactive controller and the interactive application, and generates stochastic elements by a wagering subcontroller that are communicated to the interactive application for use in the interactive wagering process. Achievement of the objectives as detected by the interactive controller based on player interactions, and the achievements of the objectives are used to determine a wagering outcome for the interactive wagering process.

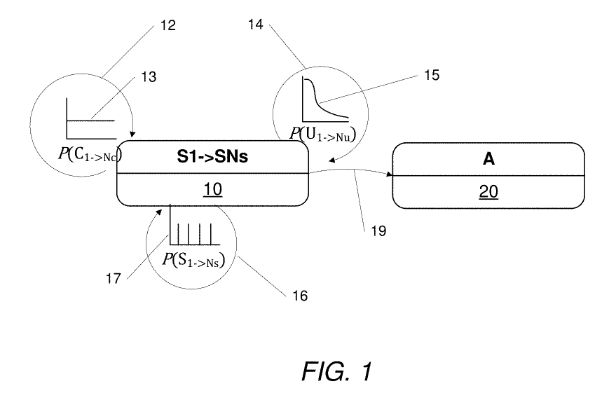

FIG. 1 is a state diagram of an interactive wagering process in accordance with various embodiments of the invention. An interactive wagering session includes determining a wagering outcome for a wager committed by a player during one or more interactive wagering processes.

In some embodiments, an interactive wagering process can be described using a state diagram having an arbitrary number of states, such as state S1 to state SN 10. A transition between some of the states may occur in response to stochastic events during an interactive wagering process, such a transition is herein termed a stochastic transition. Different types and different combinations of types of stochastic events cause transitions between some of the states of the wagering process.

In many embodiments, one or more stochastic transitions occur independently of any player interaction with the interactive wagering process and is instead a stochastic transition made by the interactive wagering process system as a result of a stochastic element generated by the interactive wagering process system, such as stochastic transition 12, where the probability that the stochastic element is generated has a known probability distribution 13.

In some embodiments, one or more stochastic transitions occur based on detection of a player's interaction with the interactive wagering process, such as stochastic transition 14. Such a stochastic transition is based upon detection by the interactive wagering process system of an interaction by a player with an interactive element of the interactive wagering process system. The probability that a player will interact with the interactive element to effect a particular stochastic transition can be described using a probability distribution 15 for the player interaction.

In various embodiments, a stochastic transition occurs as a result of detecting a player's selection made between two or more selectable interactive elements, as exemplified by stochastic transition 16 having a discrete probability distribution 17.

At an end of an interactive wagering process, the interactive wagering process transitions 19 to an achievement state 20 and a wagering outcome is determined.

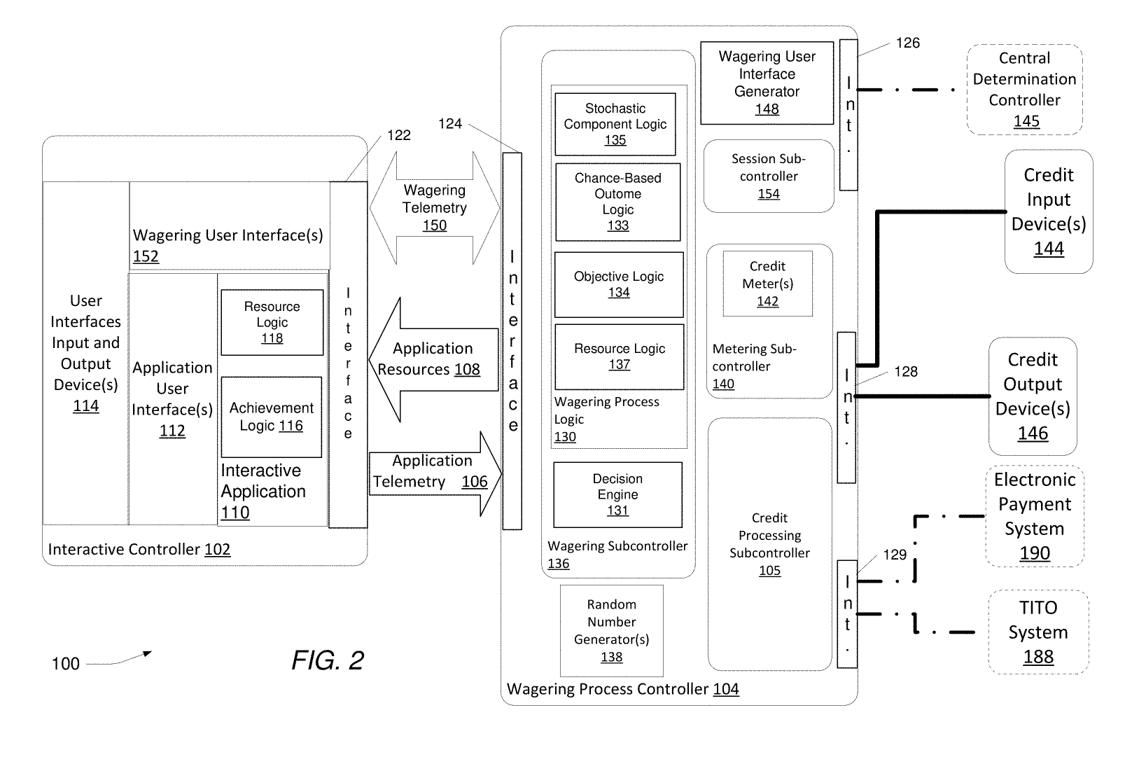

FIG. 2 is a diagram of an architecture of an interactive wagering process system in accordance with various embodiments of the invention. The interactive wagering process system is designed to implement an interactive wagering process through the generation, detection and processing of stochastic events. The interactive wagering process system 100 includes an interactive controller 102 and a wagering process controller 104. The wagering process controller 104 is also operatively connected to, and communicates with, various credit input and credit output devices and/or systems, such as one or more credit input devices 144, one or more credit output devices 146, a electronic payment system 190 and/or a ticket-in-ticket-out system 188, using a credit processing subcontroller 105.

In various embodiments, the interactive controller 102 detects player interactions with an interactive wagering process implemented by an interactive wagering process system. The interactive controller 102 executes an interactive application 110 and provides one or more user interface user input and output devices 114 so that one or more players can interact with the interactive application 110. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an application user interface 112 that utilizes the user input devices to detect player interactions with interactive elements of the interactive application 110 of the interactive controller 102 and generates an interactive user interface that is presented to the player utilizing the user output devices.

In some embodiments, one or more components of an interactive controller are housed in an enclosure such as a housing, cabinet, casing or the like. The enclosure further includes one or more player accessible openings or surfaces constructed to mount the user input devices and/or the user output devices.

The interactive controller 102 is operatively connected to, and communicates with, the wagering process controller 104. The interactive controller 102 receives application resource data 108 including, but not limited to, stochastic element data from the wagering process controller 104.

In some embodiments, during execution of the interactive application 110 by the interactive controller 102, the interactive controller 102 communicates, as application telemetry data 106, detected player interactions with one or more interactive elements of the application user interfaces 112 of the interactive application, to the wagering process controller 104. The application telemetry data 106 may include, but is not limited to, application environment variables that indicate the state of the interactive application 110, interactive controller data indicating a state of the interactive controller 102, detected player actions and interactions between one or more players and the interactive application 110 provided by the interactive controller 102, achievement of objectives based on the detected player interactions and achievement logic 116, and utilization of interactive elements of the interactive application 110 by one or more players.

In many embodiments, the interactive application 110 includes resource logic 118 utilized by the interactive application to generate one or more in-application resources and/or interactive elements in accordance with stochastic element data received from the wagering process controller 104 included in the application resource data 108.

The interactive application 110 determines one or more objective achievements based on detection of the interactions of the one or more players with interactive elements of the interactive application and communicates data of the determined objective achievements to the wagering process controller 104 as part of the application telemetry 106. In some embodiments, the interactive application 110 also communicates as part of the application telemetry data 106, data encoding the one or more players' interactions with the interactive application 110 and event data generated by the interactive application 110.

In some embodiments, the interactive application 110 is a skill-based interactive application, such as but not limited to a skill-based game. In such embodiments, during execution of the skill-based interactive application 110 by the interactive controller 102, the interactive controller 102 detects the players' skillful interaction with interactive elements of the interactive application 110 during the players' skillful interaction with the skill-based interactive application 110 to achieve an objective. In such an embodiment, the wagering process controller 104 communicates with the interactive controller 102 in order to allow the coupling of the skill-based interactive application to stochastic elements generated in accordance with an interactive wagering process implemented by the wagering process controller 104 and/or the interactive controller 102.

In various embodiments, an interactive wagering process system can include an interactive application 110 that provides for player versus player (PvP) competitive play between a single player and a computing device, between two or more players against one another, or multiple players playing against a computing device and/or each other. In such embodiments, stochastic elements of an interactive wagering process may be interjected into the competitive play to either enhance or disrupt one or more players' competitive play of the interactive application 110.

In some embodiments, the objective achievement logic 116 is communicated to the interactive controller 102 by the wagering process controller 104 as part of the application resource data 108.

In some embodiments, the resource logic 118 is communicated to the interactive controller 102 by the wagering process controller 104 as part of the application resource data 108.

In some embodiments, the interactive controller 102 includes one or more sensors (not shown) that sense various aspects of the physical environment of the interactive controller 102. Examples of sensors include, but are not limited to: global positioning sensors (GPSs) for sensing communications from a GPS system to detect a position or location of the interactive controller; temperature sensors; accelerometers; pressure sensors; and the like. Sensor telemetry data detected from the one or more sensors are communicated by the interactive controller to the wagering process controller 104 as part of the application telemetry data 106. The wagering process controller 104 receives the sensor telemetry data and uses the sensor telemetry data along with wagering process logic 130 to generate stochastic elements of an interactive wagering process as described herein.

In many embodiments, the interactive controller 102 includes one or more wagering user interfaces 152 used to display wagering data, via one or more of the user interface input and output devices 114, to one or more players. The on more wagering user interfaces include a presentation to one or more players of various wagering data that may include, but is not limited to, an amount of credits committed to a wager, a denomination of a wager, an amount of credits won as the result of a successful wager, and an amount of credits in a credit meter associated with the one or more players.

In various embodiments, an application control interface 122 resident in the interactive controller 102 provides an interface between the interactive controller 102 and the wagering process controller 104 via interface 124.

In some embodiments, interfaces 122 and 124 implement an interactive controller to wagering process controller communication protocol employing an interprocess communication protocol so that an interactive controller and a wagering process controller may be implemented on the same device. In operation, the application control interface 122 provides application programming interfaces (APIs) that are used by an interactive application of the interactive controller to communicate outgoing data and receive incoming data by passing parameter data to another process or application.

In some embodiments, interfaces 122 and 124 implement an interactive controller to wagering process controller communication protocol employing an interdevice communication protocol so that an interactive controller and a wagering process controller may be implemented on different devices. The interdevice protocol may utilize a wired communication bus or wireless network as a physical layer.

In various embodiments, interfaces 122 and 124 implement an interactive controller to wagering process controller communication protocol employing a networking protocol so that an interactive controller and a wagering process controller may be implemented on different devices connected by a network. The networking protocol may utilize a wired communication bus or wireless network as a physical layer. In many such embodiments, the network includes a cellular telephone network or the like and the interactive controller is a mobile device such as a smartphone, tablet computer or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

In several embodiments, interfaces 122 and 124 implement an encrypted communication protocol so that data communicated between the controllers may be encrypted to increase security of the interactive wagering process system.

In various embodiments, the wagering process controller 104 includes a wagering subcontroller 136 that uses interactive wagering process logic 130, and one or more random number generators 138 to generate stochastic elements used by the interactive wagering process system to perform an interactive wagering process.

In some embodiments, stochastic elements include, but are not limited to, stochastic components that are data values generated using the one or more random number generators 138 in accordance with stochastic component logic 135. In various embodiments, the stochastic components may be used in further processing by either the interactive application 110 or the wagering process controller 104 to generate one more additional stochastic elements.

In various embodiments, stochastic elements include, but are not limited to, chance-based outcomes that are wagering outcomes of an amount of credits or other items having value as described herein. The chance-based outcomes are generated in accordance with chance-based outcome logic 133 and one or more outputs from the one or more random number generators 138.

In many embodiments, stochastic elements include, but are not limited to, objectives of the interactive wagering process that one or more players achieve when interacting with the interactive application 110 as described herein. The objectives are generated in accordance with objective logic 134 and one or more outputs from the one or more random number generators 138.

In various embodiments, stochastic elements include, but are not limited to, resources of an interactive application that a player uses and/or interacts with during interaction with the interactive application as described herein. The resources are generated in accordance with resource logic 137 and one or more outputs from the one or more random number generators 138.

In many embodiments, the wagering subcontroller 136 of the wagering process controller 104 works in association with resource logic 118 of the interactive application 110. In an example embodiment, the wagering subcontroller 136 uses an output of the one or more random number generators 138 along with the stochastic component logic 135 to generate a stochastic component. The stochastic component is then communicated to the interactive controller 102, and the interactive application uses the resource logic 118 to generate one or more application resources. In other example embodiments, the wagering subcontroller 136 uses the objective logic 134 to provide a selection of an objective that is generated by the interactive application.

In several embodiments, a rule-based decision engine 131 uses the application telemetry data 106, an output of the one or more random number generators 138, along with wagering process logic 130, to generate one or more stochastic elements as described herein. In such embodiments, a decision engine 131 includes one or more rules as part of wager processing logic 130 used by a decision engine 131 to determine how a stochastic element should be generated. Each rule includes one or more variable values constituting a pattern that is to be matched by the decision engine 131 to one or more variable values encoded in an input string of data. Each rule also includes one or more actions that are to be taken if the pattern is matched. Actions can include automatically generating one or more stochastic elements in accordance with the wagering process logic 130 as described herein. During operation, the wagering process controller 104 receives application telemetry data 106 from the interactive controller 102. The wagering subcontroller uses decision engine 131 to perform a matching process of matching the variable values encoded in the application telemetry data 106 to one or more variable patterns of one or more rules. If a match between the variable values and a pattern of a rule is detected, then the wagering subcontroller 136 performs the action of the matched rule.

In various embodiments, the wagering process controller communicates data of one or more stochastic elements generated by the wagering subcontroller 136 to the interactive controller 102 as a portion of application resource data 108 communicated to the interactive controller 102.

In some embodiments, the decision engine 131 includes one or more rules as part of wagering process logic 130 used by the decision engine to automatically generate the application resource data 108 that is then communicated to the interactive controller 102.

In some embodiments, the interactive application 110 operates utilizing a scripting language. The interactive application 110 parses scripts written in the scripting language and executes commands encoded in the scripts. In operation of such embodiments, the wagering process controller 104 generates interactive application resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands as encoded in the scripts.

In many embodiments, the interactive application 110 automatically performs processes as instructed by commands communicated from the wagering process controller 104. The commands command the interactive application 110 to perform specified operations such as executing specified commands and/or setting the values of variables utilized by the interactive application 110. In operation of such embodiments, the wagering process controller 104 generates commands that are encoded into the application resource data 108 that are communicated to the interactive controller 102. The interactive controller 102 passes the resource data 108 to the interactive application 110. The interactive application parses the resource data and automatically performs operations in accordance with the commands encoded in the resource data 108.

In many embodiments, the wagering process controller 104 includes one or more interfaces, such as interface 126, that operatively connect the wagering process controller 104 to one or more external devices used to generate chance-based outcomes, such as central determination controller 145. In operation, when a wagering subcontroller 136 of the wagering process controller 104 needs a chance-based outcome, the wagering subcontroller communicates a request to the central determination controller 145 for the chance-based outcome. The central determination controller 145 receives the chance-based outcome request and generates a chance-based outcome in response to the chance-based outcome request. The central determination controller communicates data of the chance-based outcome to the wagering process controller 104. The wagering process controller 104 receives the data of the chance-based outcome and utilizes the chance-based outcome as described herein. In some embodiments, the chance-based outcome is drawn from a pool of pre-generated chance-based outcomes.

In various embodiments, the central determination controller 145 is a progressive controller that is operatively connected to a plurality of interactive wagering process systems (not shown). The progressive controller provides services for the collection and provision of credits used by the wagering process controller 104 to provide wagering outcomes that have a progressive or pooling component.

In some embodiments, the wagering process controller 104 includes one or more interfaces, such as interface 128, that operatively connect the wagering process controller 104 to one or more credit input devices, such as credit input devices 144, and to one or more credit output devices, such as credit output devices 146.

In various embodiments, the wagering process controller 104 includes one or more interfaces, such as interface 129, that operatively connect the wagering process controller 104 to one or more ticket-in-ticket-out systems 188 and/or one or more electronic payment systems 190.

The wagering process controller 104 manages one or more wagers in accordance with one or more interactive wagering processes implemented by the interactive wagering process system 100 by determining a commitment of a wager of value to the interactive wagering process, executing the interactive wagering process, and determining a wagering outcome of value of the interactive wagering process. Types of value committed to the one or more wagers can be one or more of several different types. In various embodiments, types of value of a wager can include, but are not limited to, a wager of an amount of credits corresponding to a real currency or a virtual currency, a wager of an amount of application credits earned through interaction with an interactive application, a wager of an amount of interactive elements of an interactive application, and/or a wager of an amount of objects used in an interactive application. In various embodiments, a type of value of a wagering outcome for a wager committed to a wagering process can be one or more of several different types. In various embodiments, types of value of a wagering outcome can include, but are not limited to, a wagering outcome of an amount of credits corresponding to a real currency or a virtual currency, a wagering outcome of an amount of application credits earned through interaction with an interactive application, a wagering outcome of an amount of interactive elements of an interactive application, and a wagering outcome of an amount of in-application objects used in an interactive application.

In various embodiments, a type of value of a wagering outcome of an interactive wagering process is different than a type of value of a wager commitment of the interactive wagering process. In an example embodiment, a value of a wager commitment can be an amount of credits, and a value of a wagering outcome can be an in-application object of an interactive application.

In many embodiments, the wagering process controller 104 includes one or more random number generators (RNGs) having a known stochastic behavior 138 for generating non-deterministic random numbers having a known probability distribution. The wagering subcontroller 136 uses outputs from the one or more random number generators 138 along with the wagering process logic 130 to generate one or more stochastic elements as described herein.

In many embodiments, the one or more random number generators 138 generate random numbers by continuously generating pseudorandom numbers using one or more pseudorandom number generators. A most current pseudorandom number is stored in a buffer thus constantly refreshing the buffer. In many embodiments, the buffer is refreshed at a rate of approximately 100 times per second. When the wagering subcontroller 136 requests a random number to be used to generate a stochastic element, a random number generator outputs the stored most current pseudorandom number from the buffer. As timing between the requests for a random number is non-deterministic, the resulting output from the buffer is a true non-deterministic random number. In some embodiments, a random number generator includes a plurality of pseudorandom number generators that generate and store pseudorandom numbers into a respective plurality of buffers wherein each of the pseudorandom number generators is seeded with a different seed. When a request is made to generate a random number, the random number generator generates an additional pseudorandom number and on the basis of the additional pseudorandom number, randomly selects a respective buffer to output the requested random number. In some embodiments, a respective buffer is randomly chosen by hashing a value from a realtime clock circuit to create a randomized index value that is then used to select from between the respective buffers.

In some embodiments, a stochastic component is generated by an interactive wagering process system by executing stochastic component generation instructions included in stochastic component logic to generate a stochastic component from one or more random numbers output from one or more random number generators. In various embodiments, the stochastic component is a random number. In some such embodiments, the stochastic component is a hash of a random number output by a random number generator in order to reduce the range of values of the random number so that the stochastic component can be used as an index into a lookup table.

In some embodiments, an objective is generated by an interactive wagering process system by executing objective generation commands included in objective logic that define processes of an interactive wagering process where the objective generation commands are formatted in a scripting language. In operation, a decision engine of a wagering process controller generates the objective generation commands in the form of a script written in the scripting language. The script includes the objective generation commands that describe how the wagering subcontroller is to generate data of an objective. The wagering subcontroller parses the script encoded in the objective generation command data and executes the commands included in the script to generate data of the objective.

In some embodiments, an objective is generated by an interactive wagering process system by executing objective generation commands included in objective logic to generate a stochastic component and use the stochastic component as in index into a lookup table having stored data of a plurality of objectives.

In some embodiments, an objective is generated by an interactive wagering process system by executing objective generation instructions included in objective logic to generate a stochastic component and use the stochastic component in one or more conditional statements of the objective generation instructions to control generation of data of one or more objectives.

In some embodiments, a chance-based outcome is generated by an interactive wagering process system by executing chance-based outcome generation commands included in chance-based outcome logic to generate a stochastic component and use the stochastic component as in index into a lookup table having stored data of a plurality of chance-based outcomes.

In various embodiments, a wagering process controller uses a rule-based decision engine to automatically generate an amount of application credits to award to a player based at least in part on application telemetry data including objective achievement data and player interaction data with an interactive application of the interactive wagering process system. In numerous embodiments, the interactive application is a skill-based interactive application and the application credits are awarded for a player's skillful interaction with the interactive application.

In several embodiments, the wagering process controller 104 includes a metering subcontroller 140. The metering subcontroller 140 communicates with the credit processing subcontroller 105 to receive incoming credit data from the credit processing subcontroller 105. The metering subcontroller 140 uses the incoming credit data to transfer credits into the interactive wagering process system and onto one or more credit meters 142 associated with one or more players. The metering subcontroller 140 communicates outgoing credit data to the credit processing subcontroller 105 to transfer credits off of the one or more credit meters 142 and out of the interactive wagering process system.

In various embodiments, the credit process subcontroller 105 and metering subcontroller 140 process types of value committed to the one or more wagers other than credits. In such embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the wagering subcontroller 136 uses a wagering user interface generator 148 to automatically generate wagering telemetry data 150 on the basis of amounts of credits on the one or more credit meters 142. The wagering telemetry data 150 is used by the wagering process controller 104 to command the interactive controller 102 to automatically generate one or more wagering user interfaces 152 describing a state of wagered credit accumulation and loss for the interactive wagering process system. When a player interacts with the one or more wagering user interfaces 152, wagering user interface telemetry data 150 is generated by the one or more wagering user interfaces 152 and communicated by the interactive controller 102 to the wagering process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts won, lost or accumulated.

In some embodiments, the resource data 108 are communicated to the wagering user interface generator 148 and used as a partial basis for generation of the wagering telemetry data 150 communicated to the interactive controller 102.

In various embodiments, the wagering user interface generator 148 also receives interactive wagering process state data that is used as a partial basis for generation of the wagering telemetry data 150 communicated to the interactive controller 102. In some embodiments, the interactive wagering process state data includes chance-based outcome generation data and/or objective generation data generated by the wagering subcontroller 136 during the generation of chance-based outcomes and/or objectives. In various such embodiments, the wagering user interface generator 148 generates a chance-based outcome generation process display and/or objective state display using the one or more states of the interactive wagering process. The chance-based outcome generation process display and/or objective state display is included in the wagering telemetry data 150 that is communicated to the interactive controller 102. The chance-based outcome generation process display and/or objective state display is automatically displayed by the interactive controller 102 using the one or more wagering user interfaces 152. In other such embodiments, the interactive wagering process state data are communicated to the interactive controller 102 and the interactive controller 102 is instructed to automatically generate the chance-based outcome generation process display and/or objective state display of the one or more wagering user interfaces 152.

In some embodiments, the interactive wagering process state data includes, but is not limited to, a final state, an intermediate state and/or a beginning state of the interactive wagering process. For example, in an interactive wagering process that is based on slot machine math, the final state of the interactive wagering process may be reel positions, in an interactive wagering process that is based on roulette wheel math, the final state may be a pocket where a ball may have come to rest, in an interactive wagering process that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. In operation, a wagering user interface generator of a wagering process controller generates commands in the form of a script written in the scripting language. The script includes commands that describe how the interactive controller is to display interactive wagering process state data. The completed script is encoded as wagering telemetry data and communicated to the interactive controller by the wagering process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a wagering process controller generates a document composed in the document markup language. The document includes commands that describe how the interactive controller is to display interactive wagering process state data. The completed document is encoded as wagering telemetry data and communicated to the interactive controller by the wagering process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a wagering process controller generates the commands and encodes the commands into wagering telemetry data that is communicated to the interactive controller by the wagering process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a wagering process controller communicates graphic and audio display resources as part of wagering telemetry data to an interactive controller. The interactive controller uses the graphic and audio display resources to generate a wagering user interface as described herein.

In various embodiments, the wagering user interface generator 148 processes various types of value committed to one or more wagers. In such embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the wagering process controller 104 utilizes the one or more wagering user interfaces 152 to communicate certain interactive application data to the player, including but not limited to, club points, player status, control of the selection of choices, and messages which a player can find useful in order to adjust the interactive application experience or understand the wagering status of the player.

In some embodiments, the wagering process controller 104 utilizes the one or more wagering user interfaces 152 to communicate aspects of an interactive wagering process to a player including, but not limited to, amount of credits, application credits, interactive elements, or objects in play, and amounts of credits, application credits, interactive elements, or objects available.

In a number of embodiments, the wagering subcontroller 136 can accept interactive wagering process factors including, but not limited to, modifications in the amount of credits, application credits, interactive elements, or objects wagered on each individual wagering event, entrance into a bonus round, and other factors. In several embodiments, the wagering process controller 104 can communicate a number of factors back and forth to the wagering subcontroller, such that an increase/decrease in a wagered amount can be related to the change in player profile of the player in the interactive application. In this manner, a player can control a wager amount per wagering event in accordance with the interactive wagering process with the change mapping to a parameter or component that is applicable to the interactive application experience.

In some embodiments, the wagering process controller 104 includes a session subcontroller 154 is used to regulate an interactive wagering process system session.

In various embodiments, components of the wagering process controller 104 communicate session data to the session subcontroller. The session data may include, but is not limited to, player data, interactive controller data, pooled bet and side bet data, wagering process controller data and wagering subcontroller data used by the session subcontroller to regulate an interactive wagering process system session.

In some embodiments, the session subcontroller 154 may also assert control of an interactive wagering process system session by communicating session control data to components of the wagering process controller 104. Such control may include, but is not limited to, commanding the wagering process controller 104 to end an interactive wagering process system session, initiating wagering in an interactive wagering process system session, ending wagering in an interactive wagering process system session but not ending a player's use of the interactive application portion of the interactive wagering process system, and changing from real credit wagering in an interactive wagering process system to virtual credit wagering, or vice versa.

In many embodiments, the session subcontroller 154 manages player profiles for a plurality of players. The session subcontroller 154 stores and manages data about players in order to provide authentication and authorization of players of the interactive wagering process system 100. In some embodiments, the session subcontroller 154 also manages geolocation information to ensure that the interactive wagering process system 100 is only used by players in jurisdictions were wagering is approved. In various embodiments, the session subcontroller 154 stores application credits that are associated with the player's use of the interactive application of the interactive wagering process system 100.

In some embodiments, the session subcontroller 154 communicates player and session management data to the player using a management user interface (not shown) of the interactive controller. The player interacts with the management user interface and the management user interface generates management telemetry data that is communicated to the session subcontroller 154.

In some embodiments, the wagering subcontroller 136 communicates wagering session data to the session subcontroller 154. In various embodiments, the session subcontroller communicates wagering session control data to the wagering subcontroller 136.

In many embodiments, the credit processing subcontroller 105 operatively connects to one or more credit input devices for generating incoming credit data from a credit input. Credit inputs can include, but are not limited to, credit items used to transfer credits. The incoming credit data are communicated by the credit processing subcontroller 105 to the metering subcontroller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing subcontroller 105 includes one or more credit output devices 146 for generating a credit output based on outgoing credit data 192 communicated from the wagering subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing subcontroller 105 is operatively connected to, and communicates with, a TITO system 188 or the like to determine incoming credit data representing amounts of credits to be transferred into the interactive wagering process system and to determine outgoing credit data representing amounts of credits to be transferred out of the interactive wagering process system. In operation, the credit processing subcontroller 105 communicates with a connected credit input device, such as a bill validator/ticket scanner, used to scan a credit input in the form of a TITO ticket having indicia of credit account data of a credit account of the TITO system. The credit processing subcontroller 105 communicates the credit account data to the TITO system. The TITO system uses the credit account data to determine an amount of credits to transfer to the credit processing subcontroller 105, and thus to the metering subcontroller 140 of the wagering process controller 104. The TITO system communicates the amount of credits to the credit processing subcontroller 105. The credit processing subcontroller 105 communicates the amount of credits as incoming credit data to the metering subcontroller 140 and the metering subcontroller 140 credits one or more credit meters 142 with the amount of credits so that the credits can be used when a player makes wagers using the interactive wagering process system 100.

In many embodiments, the credit processing subcontroller 105 is operatively connected to a bill validator/ticket scanner as one of the one or more credit input devices 144. The credit processing subcontroller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the interactive wagering process system 100.

In some embodiments, the credit processing subcontroller 105 can use a TITO system along with a ticket or voucher printer as one of the one or more credit output devices 146 to generate a TITO ticket as a credit output for a player. In operation, the credit processing subcontroller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing subcontroller 105. The credit processing subcontroller 105 uses the ticket or voucher printer to print indicia of the credit account data onto a TITO ticket or voucher as a credit output.

In various embodiments, a credit processing interface 156 resident in the credit processing subcontroller 105 provides an interface between the credit processing subcontroller 156 and the wagering process controller 104.

In some embodiments, the credit processing interface 156 implements a credit processing subcontroller to wagering process controller communication protocol employing an interprocess communication protocol so that the wagering process controller 104 and the credit processing subcontroller 105 may be implemented on the same device. In operation, the credit processing interface 156 provides application programming interfaces that are used by the credit processing subcontroller 105 to communicate outgoing data and receive incoming data by passing parameter data to another process or application.

In some embodiments, the credit processing interface 156 implements wagering process controller to credit processing subcontroller communication protocol employing an interdevice communication protocol so that the wagering process controller and the credit processing subcontroller may be implemented on different devices. The interdevice protocol may utilize a wired communication bus or wireless network as a physical layer.

In various embodiments, the credit processing interface 156 implements a wagering process controller to credit processing subcontroller communication protocol employing a networking protocol so that the wagering process controller 104 and the credit processing subcontroller 105 may be implemented on different devices connected by a network. The networking protocol may utilize a wired communication bus or wireless network as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing subcontroller 105 provides an interface to an electronic payment management system 190 such as an electronic wallet or the like. The electronic payment system provides credit account data that is used for generating incoming credit data as a credit input and outgoing credit data as a credit output.

In several embodiments, during operation, the metering subcontroller 140 communicates with the credit processing subcontroller 105 to receive incoming credit data from the credit processing subcontroller 105 and adds credits onto the one or more credit meters 110 at least partially on the basis of the incoming credit data. The wagering subcontroller 136 uses the interactive wagering process logic 130 and outputs from the one or more random number generators 138 to generate one or more stochastic elements. Data of the one or more stochastic elements are communicated by the wagering process controller 104, as part of the application resource and resource data 108, to the interactive controller 102. The interactive application 110 uses the stochastic element data to generate a presentation for the user including the one or more application user interfaces 112. One or more players interact with the one or more application user interfaces 112 through the one or more user interface input and output devices 114. The interactive application 110 detects the player interactions and determines an objective achievement based on the detected interactions of the one or more players using the objective achievement logic 116 and communicates data of the objective achievement as part of the application telemetry data 106 to the wagering process controller 104. The wagering subcontroller 136 receives the objective achievement data and determines a wagering outcome based on the objective achievement data, and instructs the metering subcontroller 140 to add credits to, or deduct credits from, the one or more credit meters 110 based in part on the objective achievement data. For example, in some embodiments, the metering subcontroller is instructed to add an amount of credits to a credit meter of the one or more credit meters 110 when the objective achievement indicates a win for a player associated with the credit meter. In various embodiments, the metering subcontroller is instructed to deduct an amount of credits from the credit meter when the objective achievement indicates a loss for the player. At an end of a wagering session, the metering subcontroller 140 transfers credits off of the one or more credit meters 110 and out of the interactive wagering process system by communicating outgoing credit data to the credit processing subcontroller 105 The credit processing subcontroller 105 uses outgoing credit data to generate one or more credit output items using the one or more credit output devices 146.

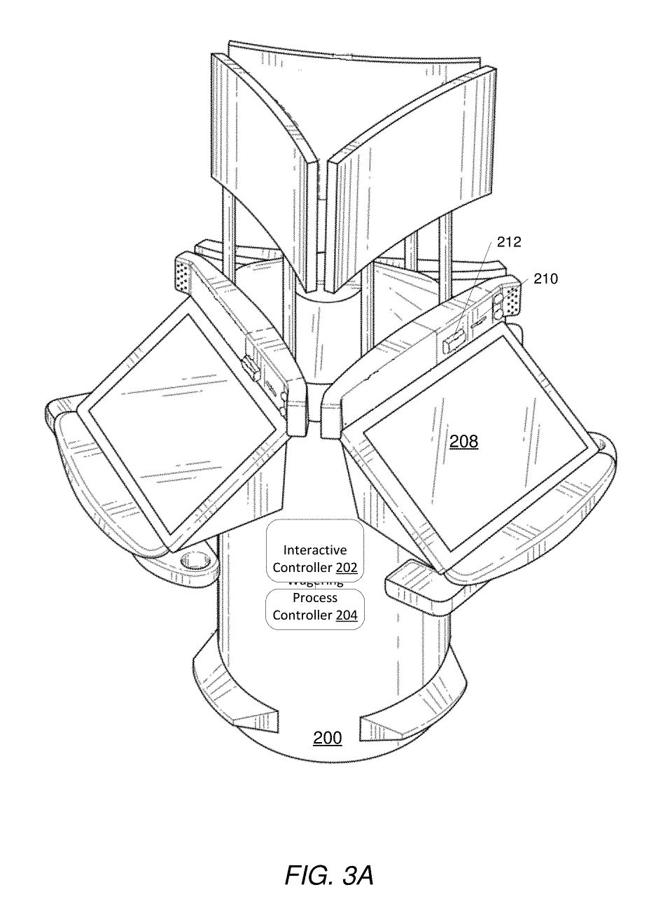

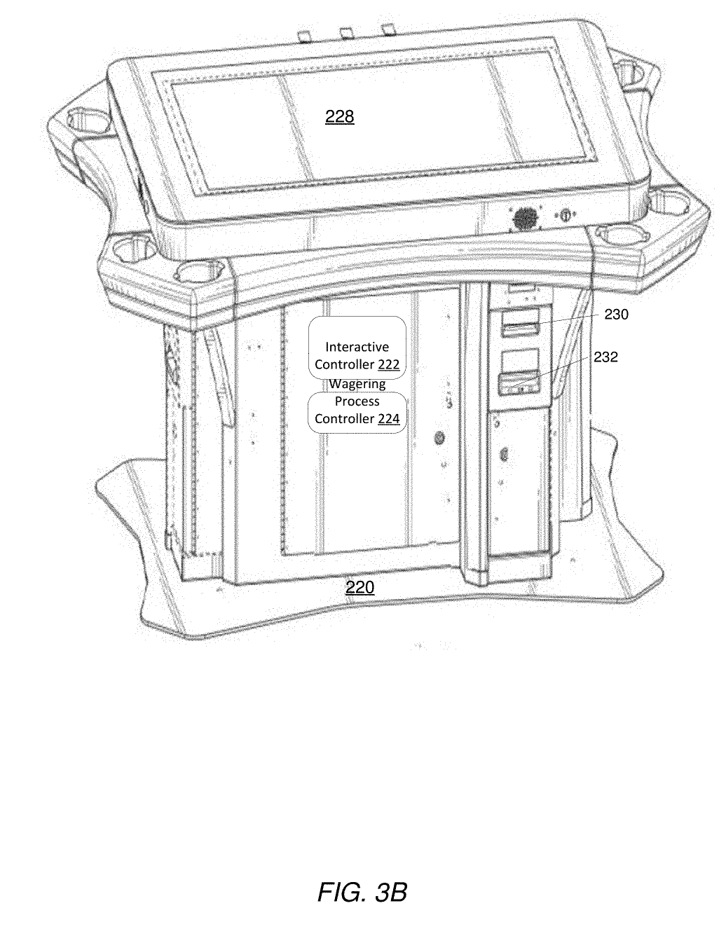

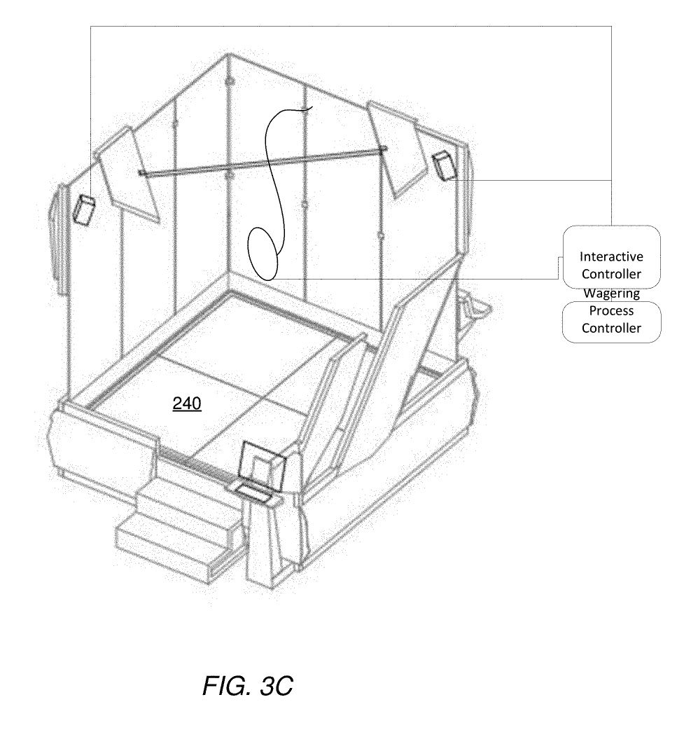

FIG. 3A is a diagram of an electronic gaming machine configuration of an interactive wagering process system in accordance with various embodiments of the invention. Electronic gaming machine configurations of an interactive wagering process system include, but are not limited to, electronic gaming machines such as slot machines, table games, video arcade consoles and the like. An electronic gaming machine configuration of an interactive wagering process system 200 includes an interactive controller 202 as described herein and a wagering process controller 204 as described herein contained in an enclosure such as a housing, cabinet, casing or the like. The enclosure may further include one or more player accessible openings or surfaces that may be used to mount one or more player accessible user input devices and user output devices 208 as described herein, one or more player accessible credit input devices 210 and one or more player accessible credit output devices 212 as described herein. The interactive controller 202 communicates with the user input devices to detect player interactions with the interactive wagering process system and commands and controls the user output devices to provide a user interface to one or more players of the interactive wagering process system as described herein. The wagering process controller 204 communicates using a credit processing subcontroller to one or more player credit processing devices, such as credit input device 210 and credit output device 212 to transfer credits into and out of the interactive wagering process system as described herein.

In various embodiments, the wagering process controller 204 uses a credit processing subcontroller operatively connected to one or more credit input devices 210 for generating incoming credit data from a credit input as described herein.

In various embodiments, the credit processing subcontroller is operatively connected to the one or more credit output devices 212 for generating a credit output based on outgoing credit data communicated from the wagering process controller 204 as described herein.

In some embodiments, the credit processing subcontroller is operatively connected to, and communicates with, a TITO system (not shown) or the like to determine incoming credit data representing amounts of credits to be transferred into the interactive wagering process system 200 and to generate outgoing credit data representing amounts of credits to be transferred out of the interactive wagering process system 200 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the wagering process controller 204 is operatively connected to a central determination controller (not shown) as described herein.

In various embodiments, the wagering process controller 204 may be operatively connected to a progressive controller along (not shown) with one or more other wagering process controllers of one or more other interactive wagering process systems as described herein.

FIG. 3B is a diagram of multiplayer or multiplayer electronic gaming machine configuration of an interactive wagering process system in accordance with various embodiments of the invention. Types of a multiplayer or multiplayer electronic gaming machine configuration an interactive wagering process system include, but are not limited to, multiplayer or multiplayer electronic gaming machines, multiplayer or multiplayer slot machines, multiplayer or multiplayer table gaming devices, multiplayer or multiplayer video arcade consoles and the like. A multiplayer or multiplayer electronic gaming machine configuration of an interactive wagering process system 220 includes an interactive controller 222 as described herein and a wagering process controller 224 as described herein contained in an enclosure such as a housing, cabinet, casing or the like. The enclosure may further include one or more player accessible openings or surfaces that may be used to mount one or more player accessible user input devices and user output devices 228 as described herein, one or more player accessible credit input devices 230 as described herein and one or more player accessible credit output devices 232 as described herein.

In some embodiments, two or more sets of credit input devices and credit output devices are provided so that each player of the multiplayer or multiplayer electronic gaming machine configuration of an interactive wagering process system 220 can have an associated set of credit input devices and credit output devices.

The interactive controller 222 communicates with the user input devices to detect player interactions with the interactive wagering process system and commands and controls the user output devices to provide a user interface to one or more players of the interactive wagering process system as described herein. The wagering process controller 224 communicates with the credit processing subcontroller 226 or player credit processing devices 230 and 232 to transfer credits into and out of the interactive wagering process system as described herein.

In various embodiments, the wagering process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the wagering process controller 224 as described herein.

In some embodiments, the credit processing subcontroller is operatively connected to, and communicates with, a TITO system (not shown) or the like to determine incoming credit data representing amounts of credits to be transferred into the interactive wagering process system 220 and to generate outgoing credit data representing amounts of credits to be transferred out of the interactive wagering process system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the wagering process controller 224 is operatively connected to a central determination controller (not shown) as described herein.

In various embodiments, the wagering process controller 224 may be operatively connected to a progressive controller along (not shown) with one or more other wagering process controllers of one or more other interactive wagering process systems as described herein.

FIG. 3C is a diagram of virtual reality gaming machine configuration of an interactive wagering process system in accordance with various embodiments of the invention. Types of a virtual reality gaming machine configuration of an interactive wagering process system include, but are not limited to, virtual reality gaming machines, virtual reality slot machines, virtual reality gaming devices, virtual reality arcade consoles and the like. A virtual reality gaming machine 240 configuration of an interactive wagering process system includes an interactive controller, a wagering process controller and a credit processing subcontroller contained in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality gaming machine configuration of an interactive wagering process system further includes a player area having virtual reality sensors for sensing player interactions and/or player movements within the player area, a player headset having a stereoscopic visual display for presentation of a stereoscopic presentation to a player, headphones for presenting a stereophonic sound presentation to a player, and one or more subwoofers for providing a hepatic or low frequency auditory presentation to the player.

The interactive controller communicates with the user input devices to detect player interactions with the virtual reality interactive wagering process system and commands and controls the user output devices to provide a user interface to one or more players of the virtual reality interactive wagering process system as described herein. The wagering process controller communicates with the credit processing subcontroller or player credit processing devices and to transfer credits into and out of the interactive wagering process system as described herein.

In many embodiments, the wagering process controller is further connected to one or more side betting terminals that enable spectators of a player using the virtual reality interactive wagering process system to make side bets based on the performance of the player.

In various embodiments, the wagering process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the wagering process controller 224 as described herein.

In some embodiments, the credit processing subcontroller is operatively connected to, and communicates with, a TITO system (not shown) or the like to determine incoming credit data representing amounts of credits to be transferred into the interactive wagering process system 220 and to generate outgoing credit data representing amounts of credits to be transferred out of the interactive wagering process system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the wagering process controller 224 is operatively connected to a central determination controller (not shown) as described herein.

In various embodiments, the wagering process controller 224 may be operatively connected to a progressive controller along (not shown) with one or more other wagering process controllers of one or more other interactive wagering process systems as described herein.

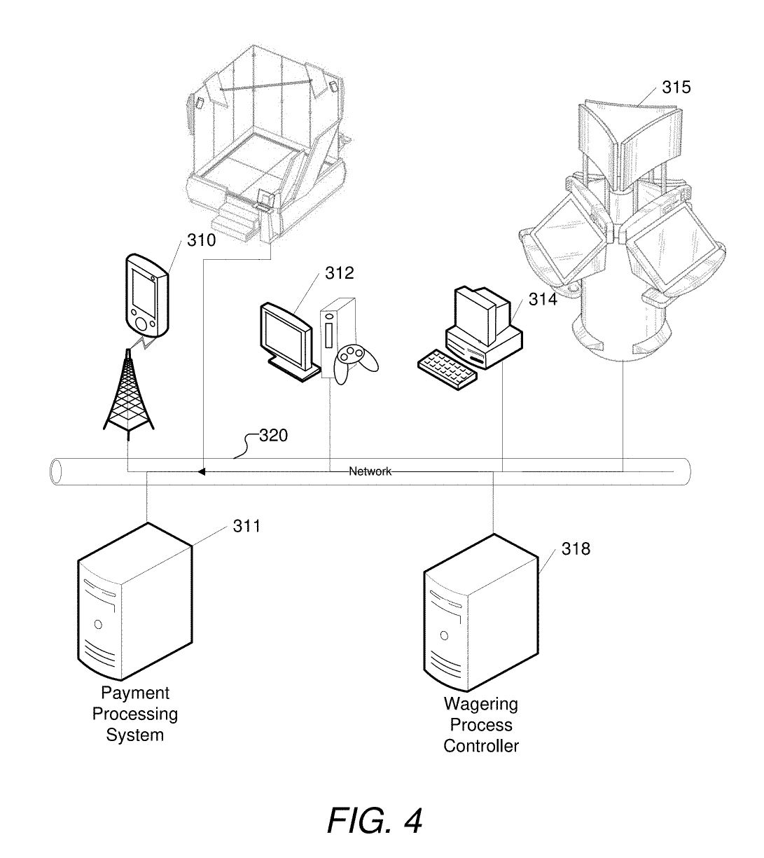

FIG. 4 is a diagram of distributed interactive wagering process systems in accordance with various embodiments of the invention. An interactive controller, such as interactive controller 102 of FIG. 1, may be constructed from or configured using one or more processing devices that perform the operations of the interactive controller. An interactive controller in a distributed interactive wagering process system may be constructed from or configured using any processing device having sufficient processing and communication capabilities to perform the processes of an interactive controller in accordance with various embodiments of the invention. In some embodiments, the construction or configuration of the interactive controller may be achieved through the use of an application control interface, such as application control interface 122 of FIG. 1, and/or through the use of an interactive application, such as interactive application 110 of FIG. 1.

In various embodiments, an interactive application may require extensive processing resources from an interactive controller leaving few processing resources for the functions performed by a wagering process controller and/or a wagering subcontroller. By virtue of the architecture described herein, processing loads may be distributed across multiple devices such that operations of the interactive controller may be dedicated to the interactive application and the processes of the wagering process controller and/or wagering subcontroller are not burdened by the requirements of the interactive application.

In many embodiments, an interactive wagering process system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of an interactive wagering process system are distributed in close proximity to each other and communicate using a local area network and/or a communication bus. In several embodiments, an interactive controller and a wagering process controller of an interactive wagering process system are in a common location and communicate with an external wagering subcontroller. In some embodiments, a wagering process controller and a wagering subcontroller of an interactive wagering process system are in a common location and communicate with an external interactive controller. In many embodiments, an interactive controller, a wagering process controller, and a wagering subcontroller of an interactive wagering process system are located in a common location. In some embodiments, a session subcontroller is located in a common location with a wagering process controller and/or a wagering subcontroller.

In various embodiments, these multiple devices can be constructed from or configured using a single device or a plurality of devices such that an interactive wagering process system is executed as a system in a virtualized space such as, but not limited to, where a wagering process controller is a large scale centralized server in a cloud networking environment operatively connected to widely distributed interactive controllers via a wide area network such as the Internet or a local area network. In such embodiments, the components of an interactive wagering process system may communicate using a networking protocol or other type of device-to-device communications protocol.

In some embodiments, an interactive wagering process system is deployed over a local area network or a wide area network in a mobile configuration. A mobile configuration of an interactive wagering process system is useful for deployment over wireless communication network, such as a wireless local area network or a wireless telecommunications network. A mobile configuration of an interactive wagering process system includes an interactive controller operatively connected by a wireless network to a wagering process controller and a wagering subcontroller.

In numerous embodiments, an interactive application server provides a host for managing head-to-head play operating over a network of interactive controllers connected to the interactive application server using a communication link. The interactive application server provides an environment where players can compete directly with one another and interact with other players.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314, 315 and a virtual reality gaming machine may be used to construct a complete interactive wagering process system and may be operatively connected using a communication link to a session and/or management controller.

Some interactive wagering process systems in accordance with many embodiments of the invention can be distributed across a plurality of devices in various configurations. One or more interactive controllers of a distributed interactive wagering process system, such as but not limited to, a mobile or wireless device 310, a gaming console 312, a personal computer 314, an electronic gaming machine 315, and a virtual reality gaming machine are operatively connected with a wagering process controller 318 of a distributed interactive wagering process system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a wagering process controller as described herein are executed on the individual interactive controllers 310, 312, 314, 315 and a virtual reality gaming machine while one or more processes of a wagering process controller as described herein can be executed by the wagering process controller 318.

In many embodiments, a distributed interactive wagering process system and may be operatively connected using a communication link to a session controller (not shown), that performs the processes of a session controller as described herein.

In several embodiments, a distributed interactive wagering process system and may be operatively connected using a communication link to credit processing system 311, that performs the processes of one or more credit processing systems as described herein.

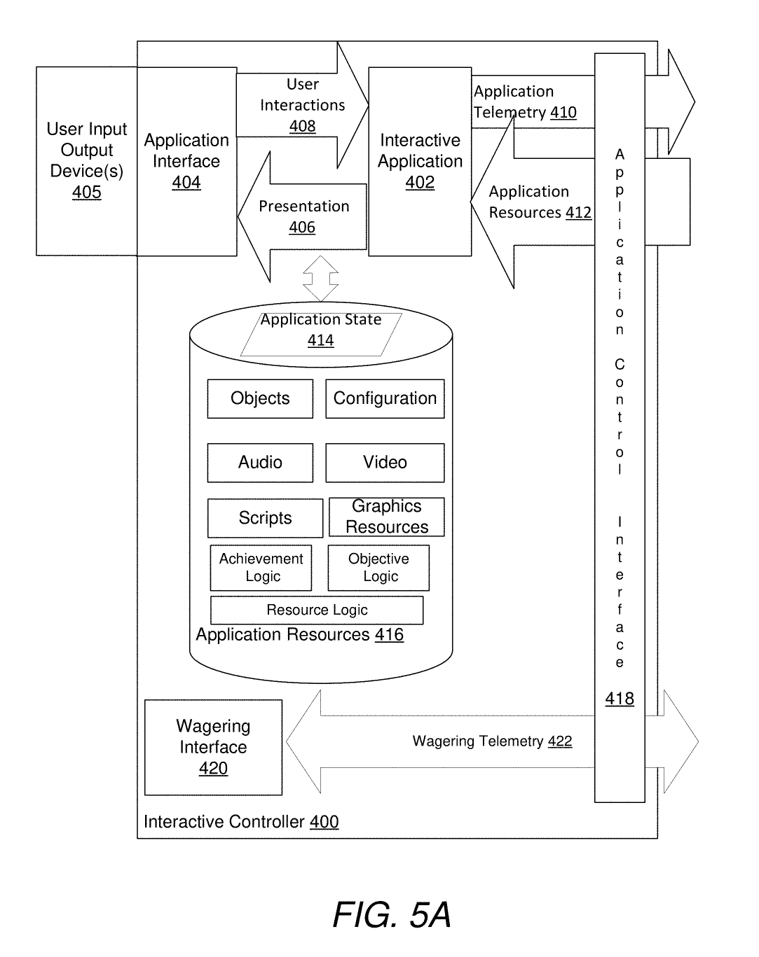

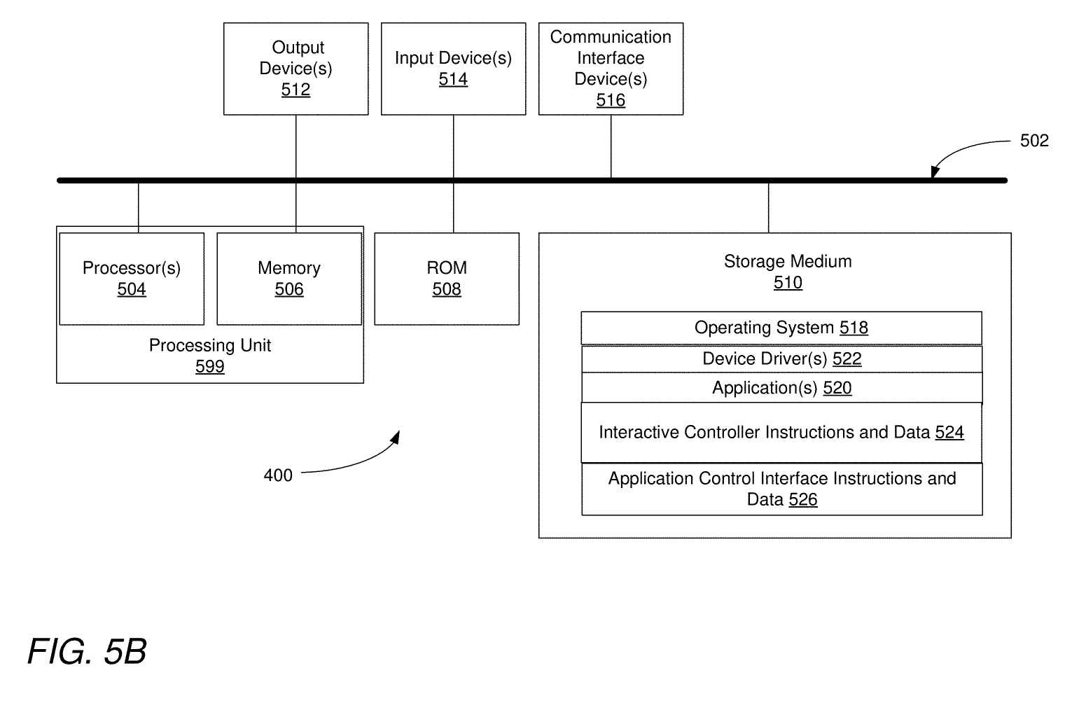

FIGS. 5A and 5B are architecture diagrams of an interactive controller in accordance with various embodiments of the invention. Referring now to FIG. 5A, an interactive controller 400, suitable for use as interactive controller 102 of FIG. 1, provides an execution environment for an interactive application 402 of an interactive wagering process system. In several embodiments, an interactive controller 400 of an interactive wagering process system provides an interactive application 402 that generates an application interface 404 for interaction with by one or more players. The interactive application 402 generates a player presentation 406 that is presented to the player through the application interface 404 using one or more user input and output devices 405. The player presentation 406 may include audio features, visual features or tactile features, or any combination of these features. In various embodiments, the application interface 404 utilizes one or more user interface input and output devices 405 so that a player can interact with the player presentation 406. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 to various other components of an interactive wagering process system as described herein. The interactive application 402 receives application resources 412 communicated from various other components of an interactive wagering process system as described herein. In some embodiments, the application telemetry data 410 may include player interactions with objects of the interactive application and an objective achievement for an objective presented to the player by the interactive application 402.

In some embodiments, various components of the interactive application 402 can read game state data from an application game state datastore 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between virtual objects in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application game state to the player. The audio engine is used to generate an audio representation of the interactive application game state to the player.

During operation, the interactive application reads and writes application resources 416 stored on a data store of the interactive controller 400. The application resources 416 may include objects having graphics and/or control logic used to provide application environment objects of the interactive application. In various embodiments, the resources may also include, but are not limited to, video files that are used to generate a portion of the player presentation 406; audio files used to generate music, sound effects, etc. within the interactive application; configuration files used to configure the features of the interactive application; scripts or other types of control code used to provide various features of the interactive application; graphics resources such as textures, objects, etc. that are used by a graphics engine to render objects displayed in an interactive application; objective achievement logic used to detect an objective achievement of an objective using player interactions with the player presentation; resource logic used by the interactive application to generate application resources; and objective logic used by the interactive application to generate one or more objectives.

In operation, components of the interactive application 402 read portions of the application game state datastore 414 and generate the player presentation 406 for the player that is presented to the player using the user interface 404. The player perceives the player presentation and provides player interactions 408 using the user input devices. The corresponding player interactions are received as player actions or inputs by various components of the interactive application 402. The interactive application 402 translates the player actions into interactions with the virtual objects of the application environment stored in the application game state datastore 414. Components of the interactive application use the player interactions with the virtual objects of the interactive application and the interactive application game state datastore 414 to update the application game state datastore 414 and update the player presentation 406 presented to the player. The process loops continuously while the player interacts with the interactive application of the interactive wagering process system.

The interactive controller 400 provides one or more interfaces 418 between the interactive controller 400 and other components of an interactive wagering process system, such as, but not limited to, a wagering process controller. The interactive controller 400 and the other interactive wagering process system components communicate with each other using the interface. The interface may be used to pass various types of data, and to communicate and receive messages, status data, commands and the like. In certain embodiments, the interactive controller 400 and a wagering process controller communicate application resources 412 and application telemetry data 410. In some embodiments, the communications include requests by the wagering process controller that the interactive controller 400 update the application game state datastore 414 using data provided by the wagering process controller.

In many embodiments, communications between a wagering process controller and the interactive controller 400 includes a request that the interactive controller 400 update one or more resources 416 using data provided by the wagering process controller. In a number of embodiments, the interactive controller 400 provides all or a portion of the application game state to the wagering process controller. In some embodiments, the interactive controller 400 may also provide data about one or more of the application resources 416 to the wagering process controller. In some embodiments, the communication includes player interactions that the interactive controller 400 communicates to the wagering process controller. The player interactions may be low level player interactions with the user interface 404, such as manipulation of an input device, or may be high level player interactions with game world objects as detected by the interactive application. The player interactions may also include resultant actions such as modifications to the application game state datastore 414 or game resources 416 resulting from the player's interactions taken in the interactive wagering process system interactive application. In some embodiments, player interactions include, but are not limited to, actions taken by entities such as non-player characters (NPCs) of the interactive application that act on behalf of or under the control of the player.

In various embodiments, the application resources 412 include application resources used by the interactive application 402 to generate a presentation of an interactive wagering process presented to a player and to detect an objective achievement based on the player's skillful interaction with the. In many such embodiments, data of the application resources 412 includes data of one or more stochastic elements as described herein.

In some embodiments, the interactive controller 400 includes a wagering user interface 420 used to provide interactive wagering process system telemetry data 422 to and from the player. The interactive wagering process system telemetry data 422 from the interactive wagering process system includes, but is not limited to, data used by the player to configure a wager, data used to communicate a state of an interactive wagering process, and data about a wagering outcome.

In some embodiments, the interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the interactive wagering process system.

Referring now to FIG. 5B, interactive controller 400 includes a bus 502 that provides an interface for one or more processors 504, random access memory (RAM) 506, read only memory (ROM) 508, machine-readable storage medium 510, one or more user output devices 512 as described herein, one or more user input devices 514 as described herein, and one or more communication interface devices 516 for implementing one or more interfaces as described herein.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

The one or more communication interface devices 516 provide one or more wired or wireless interfaces for communicating data and commands between the interactive controller 400 and other devices that may be included in an interactive wagering process system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and interactive wagering process system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of an interactive wagering process system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of an interactive wagering process system includes an interactive application server operatively connected to an interactive client using a communication link. The interactive application server and interactive application client cooperate to provide the features of an interactive controller as described herein.

In various embodiments, the interactive controller 400 may be used to construct other components of an interactive wagering process system as described herein.

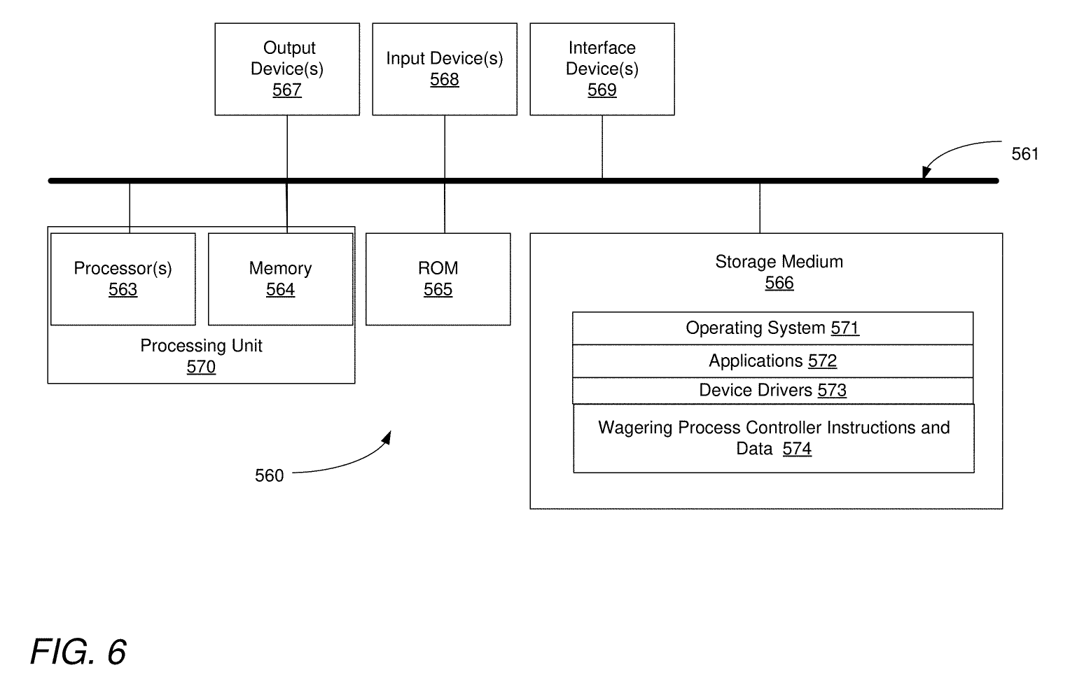

FIG. 6 is an architecture diagram of a wagering process controller, suitable for use as wagering process controller 104 of FIG. 1, of an interactive wagering process system in accordance with various embodiments of the invention. A wagering process controller may be constructed from or configured using one or more processing devices that perform the operations of the wagering process controller. In many embodiments, a wagering process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Wagering process controller 560 includes a bus 561 providing an interface for one or more processors 563, random access memory (RAM) 564, read only memory (ROM) 565, machine-readable storage medium 566, one or more user output devices 567 as described herein, one or more user input devices 568 as described herein, and one or more communication interface and/or network interface devices 569 used to implement one or more interfaces as described herein.

The one or more processors 563 may take many forms, such as, but not limited to: a central processing unit (CPU); a multi-processor unit (MPU); an ARM processor; a programmable logic device; or the like.

In the example embodiment, the one or more processors 563 and the random access memory (RAM) 564 form a wagering process controller processing unit 570. In some embodiments, the wagering process controller processing unit includes one or more processors operatively connected to one or more of a RAM, ROM, and machine-readable storage medium; the one or more processors of the wagering process controller processing unit receive instructions stored by the one or more of a RAM, ROM, and machine-readable storage medium via a bus; and the one or more processors execute the received instructions. In some embodiments, the wagering process controller processing unit is an ASIC (Application-Specific Integrated Circuit). In some embodiments, the wagering process controller processing unit is a SoC (System-on-Chip).

The one or more communication interface and/or network interface devices 569 provide one or more wired or wireless interfaces for exchanging data and commands between the wagering process controller 560 and other devices that may be included in an interactive wagering process system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 566 stores machine-executable instructions for various components of the wagering process controller 560 such as, but not limited to: an operating system 571; one or more applications 572; one or more device drivers 573; and interactive wagering process system wagering process controller instructions and data 574 for use by the one or more processors 563 to provide the features of a wagering process controller as described herein.

In various embodiments, the machine-readable storage medium 566 is one of a (or a combination of two or more of) a hard drive, a flash drive, a DVD, a CD, a flash storage, a solid state drive, a ROM, an EIEPROM, and the like.

In operation, the machine-executable instructions are loaded into memory 564 from the machine-readable storage medium 566, the ROM 565 or any other storage location. The respective machine-executable instructions are accessed by the one or more processors 563 via the bus 561, and then executed by the one or more processors 563. Data used by the one or more processors 563 are also stored in memory 564, and the one or more processors 563 access such data during execution of the machine-executable instructions. Execution of the machine-executable instructions causes the one or more processors 563 to control the wagering process controller 560 to provide the features of an interactive wagering process system wagering process controller as described herein.

Although the wagering process controller 560 is described herein as being constructed from or configured using one or more processors and instructions stored and executed by hardware components, the wagering process controller can be composed of only hardware components in accordance with other embodiments. In addition, although the storage medium 566 is described as being operatively connected to the one or more processors through a bus, those skilled in the art of wagering process controllers will understand that the storage medium can include removable media such as, but not limited to, a USB memory device, an optical CD ROM, magnetic media such as tape and disks. Also, in some embodiments, the storage medium 566 may be accessed by processor 563 through one of the interfaces or using a communication link. Furthermore, any of the user input devices or user output devices may be operatively connected to the one or more processors 563 via one of the interfaces or using a communication link.

In various embodiments, the wagering process controller 560 may be used to construct other components of an interactive wagering process system as described herein.

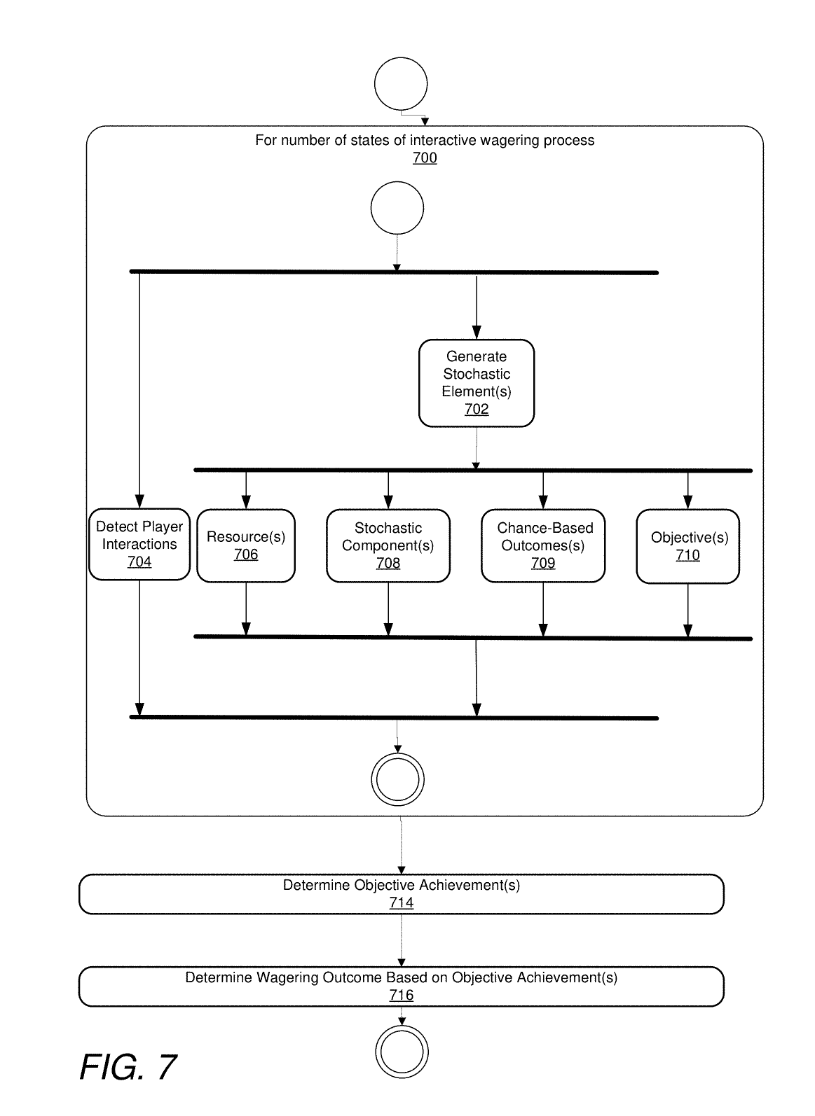

FIG. 7 is an activity diagram of interactive wagering process of an interactive wagering process system during a wagering session in accordance with various embodiments of the invention. In many embodiments, an interactive wagering process system determines 716 a wagering outcome for an interactive wagering process by executing one or more iterations of an interactive wagering process where the interactive wagering process system detects stochastic events in the form of player interactions and generates stochastic events in the form of stochastic elements as described herein. In an example embodiment, an interactive wagering process for a number of states of the interactive wagering process 700, while in a state that is expecting a stochastic transition, the interactive wagering process system may detect one or more player interactions 704 that cause a transition to a next state; may generate one or more stochastic elements 702 such as one or more resources 706, one or more stochastic components 708, one or more chance-based outcomes 709, and/or one or more objectives 710, thus causing a transition to a next state. The interactive wagering process system determines 714 one or more objective achievements. The objective achievements are determined based on one or more objectives and the one or more of the detected player interactions, and the one or more stochastic elements. The interactive wagering process system uses the one or more objective achievements to determine 716 a wagering outcome for the interactive wagering process.

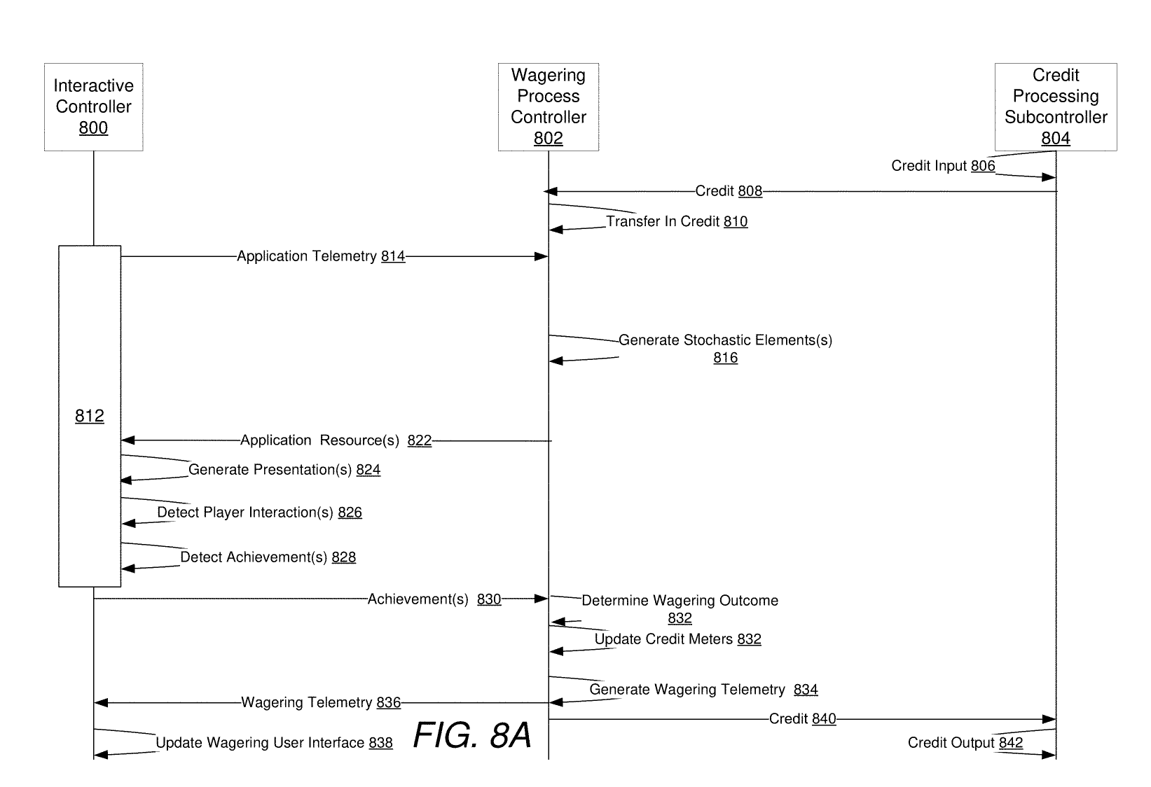

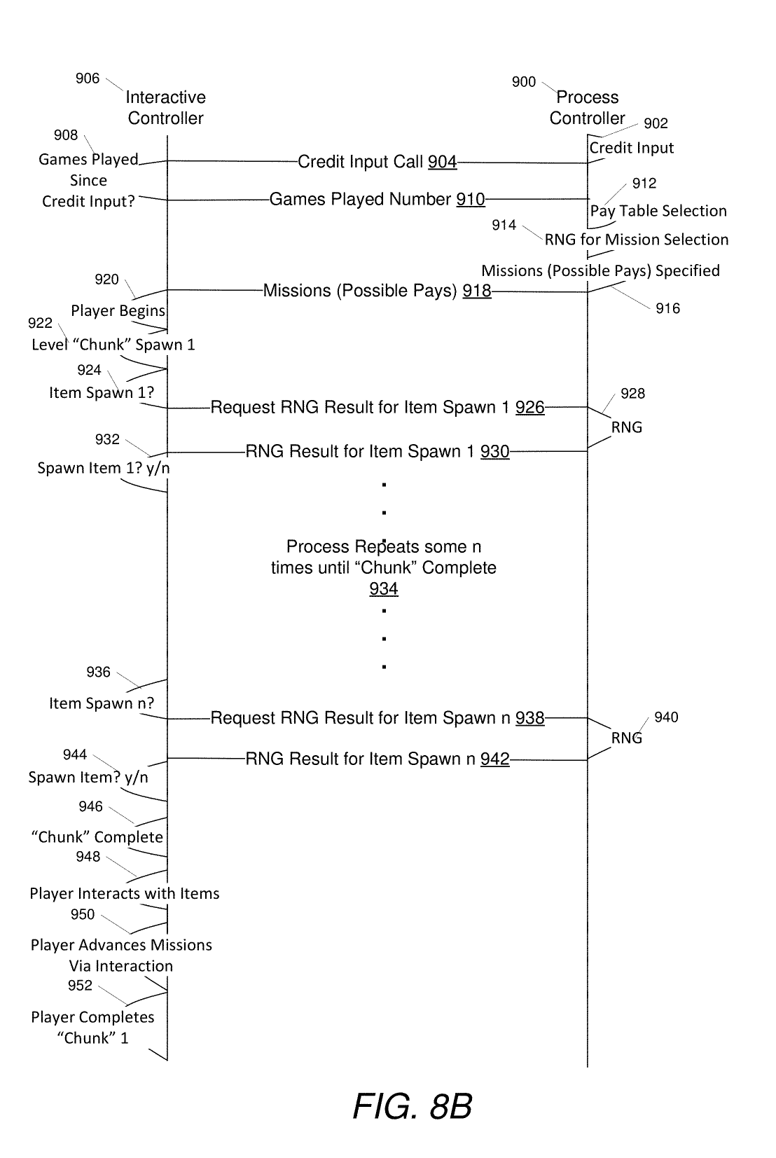

FIG. 8A is a sequence diagram of interactions between components of an interactive wagering process system during a wagering session in accordance with various embodiments of the invention. In some embodiments, at a beginning of the wagering session, the process includes a credit input 806 to the interactive wagering process system with a wagering process controller 802 communicating with a credit processing subcontroller 804 to receive incoming credit data 808. The wagering process controller 802 uses the incoming credit data to transfer 810 credits onto one or more player credit meters associated with one or more players of the interactive wagering process system, thus transferring credits into the interactive wagering process system and on to the one or more player credit meters.

During an interactive wagering process 812, an interactive controller 800 communicates application telemetry data 814 to the wagering process controller 802. The application telemetry data 814 includes, but is not limited to, data of one or more player interactions detected by the interactive controller 800 and/or one or more interactive application events.

The wagering process controller 802 receives the application telemetry data 814. Upon determination by the wagering process controller 802 that the application telemetry indicates a stochastic element of the interactive wagering process is to be generated in accordance with a state of the interactive wagering process, the wagering process controller 802 generates 816 one or more stochastic elements.

In some embodiments, the wagering process controller 802 communicates data of the stochastic components to the interactive controller 800 as application resource and resource data 822.

In many embodiments, the wagering process controller 802 generates 816 one or more stochastic components and uses the one or more stochastic components to generate the one or more objectives of the interactive wagering process.

In various embodiments, the wagering process controller 802 generates 818 one or more chance-based outcomes and uses the one or more chance-based outcomes to generate the one or more objectives of the interactive wagering process.

The interactive controller 800 receives the objective data 822 from the wagering process controller 824 and uses the objective data 822 to generate and present 818 to the one or more players one or more objectives of the interactive wagering process within the context of an interactive application as described herein. The presentation of the one or more objectives is presented to the one or more players in a user interface of the interactive application of the interactive controller 800. The interactive controller 800 detects 826 one or more player interactions of the one or more players with the presentation of the one or more objectives and detects 828 one or more objective achievements for the one or more objectives based on the detected player interactions and the objective data 816. The one or more objective achievements indicate whether or not a player has been able to achieve one or more of the one or more objectives. The interactive controller 800 communicates data of the one or more objective achievements 830 to the wagering process controller 802.

The wagering process controller 802 receives the objective achievement data 830 and determines a wagering outcome for the interactive wagering process using the data of the one or more objective achievements of the one or more objectives. The wagering process controller updates 832 the one or more player credit meters associated with the one or more players based on the wagering outcome for the interactive wagering process, such as by incrementing an amount of credit to, or decrementing an amount of credit from, the one or more player credit meters.

The wagering process controller 802 generates 834 wagering telemetry data 836 using the objective achievement data 824 and data of the updated one or more credit meters. The wagering process controller 802 communicates the wagering telemetry data 836 to the interactive controller 800. The interactive controller 800 receives the wagering telemetry data 836 and the interactive controller 800 updates 838 a wagering user interface on a partial basis of the wagering telemetry data 836.

In many embodiments, upon determining that a wagering session is completed, such as by receiving a cashout communication from one or more players of the interactive wagering process system, the wagering process controller 802 transfers credits off of the one or more player credit meters, generates outgoing credit data 840 on the basis of the credits transferred off of the one or more player credit meters, and communicates the outgoing credit data 840 to the credit processing subcontroller 804. The credit processing subcontroller 804 receives the outgoing credit data 840 and generates 842 a credit output as described herein, thus transferring credits off of the one or more player credit meters and out of the interactive wagering process system.

In various embodiments, a wagering process controller provides one or more stochastic components to an interactive controller. The interactive controller receives the stochastic components and uses the stochastic components to generate one or more objectives of an interactive wagering process as described herein.

In many embodiments, one or more stochastic components are used to generate one or more chance-based outcomes that are included in one or more objectives. The one or more chance-based outcomes are awarded to a player for achieving the one or more objectives.

In some embodiments, at a beginning of the wagering session, the process includes an application credit input to the interactive wagering process system with the wagering process controller 802 communicating with the credit processing subcontroller 803 to receive incoming application credit data. The wagering process controller 802 uses the incoming application credit data to transfer application credits onto one or more application credit meters associated with one or more players of the interactive wagering process system, thus transferring application credits into the interactive wagering process system and on to the one or more application credit meters. The wagering process controller 802 uses the objective achievement data 830 to generate an amount of application credit to award to a player based on the player's achievement of one or more objectives. Upon determining that the wagering session is completed, such as by receiving a cashout communication from one or more players of the interactive wagering process system, the wagering process controller 802 transfers application credits off of the one or more application credit meters, generates outgoing application credit data on the basis of the application credits transferred off of the one or more application credit meters, and communicates the outgoing application credit data to the credit processing subcontroller 803. The credit processing subcontroller receives the outgoing application credit data and generates an application credit output as described herein, thus transferring application credits off of the one or more application credit meters and out of the interactive wagering process system.

FIG. 8B is another sequence diagram of interactions between components of an interactive wagering process system during a wagering session in accordance with various embodiments of the invention. In various embodiments, levels within a skill-based game provided by an interactive controller as an interactive application are divided into components (“Chunks”) that are procedurally generated during a player's run. When a “Chunk” is being generated, virtual objects are randomly selected to inhabit the “chunk.” Virtual objects can be both beneficial to the player and harmful (e.g. vehicles that help the player, zappers that end the player's run) “virtual object” thus used to describe both beneficial items and obstacles. Vol.=Volatility.

In some embodiments, volatility and difficulty of missions objectives are adjusted to give a player a better first time user experience. A volatility index for a set of mission objectives generated by an interactive wagering process system is a measure of how value awarded to a player for achieving mission objectives vary as a sequence of mission objectives is generated. A set of mission objectives having low volatility index does not have a large variance in value awarded to the player, while a set of mission objectives with a high volatility index has large variances in value awarded to a player for achieving a mission objective. A volatility index is analogous to a confidence interval for set of data.

In various embodiments, mission objectives are generated using a lookup table of mission objectives and a random component as an index into the lookup table as described herein. A volatility index for a set of mission objectives generated using a lookup table can be calculated by:

Vi=C*\sqrt{Σᵢ₌₁^{N}Pᵢ(Oᵢ−EV)²}

Where:

Vi=Volatility index in units of wager value.

C=critical value of the confidence interval.

N=number of unique mission objectives in the lookup table.

Oi=value of the ith unique mission objective in units of wager value.

Pi=probability that chance-based Oi will be generated.

EV=expected value of set of mission objectives generated using the lookup table in units of wager value.

In an example embodiment, during a wagering session, mission objectives are chosen such that for a first two wagers, the volatility and difficulty of the mission objectives are low. For wagers three through six, the volatility of the mission objectives are medium, and for the seventh and subsequent wagers, the volatility and difficulty of the mission objectives are high.

During an interactive wagering process, a wagering process controller 900 receives a credit input 902 and communicates 904 that a credit input has been made to an interactive controller 906. The interactive controller 906 determines 908 how many interactive wagering games have been played by the player since the last credit input. The interactive controller communicates the number of games played 910 to the wagering process controller. The wagering process controller receives the number of games played and determines 912 a pay table selection based on the number of games played. In some embodiments, the more games that have been played, the higher the volatility of the selected paytable. That is, there is a direct correspondence between the number of games played and the volatility of a paytable selected for the player. The wagering process controller generates 914 a stochastic element and uses the stochastic element (RNG) to determine one or more specified objectives (missions) 916. The wagering process controller communicates 918 the specified objectives (missions) to the interactive controller. The interactive controller detects 920 that the player begins playing the interactive wagering game. The interactive controller generates 922 a portion of the interactive presentation (chunk) to present to the player. Within the portion of the interactive presentation, one or more virtual objects will be generated (spawned). To generate a virtual object, the interactive controller communicates 926 to the wagering process controller a request for a stochastic element (RNG result) to determine if the interactive controller is to generate (spawn) the virtual object. The wagering process controller receives the request and generates 928 a stochastic element (RNG). The wagering process controller communicates 930 the stochastic element (RNG) to the interactive controller. The interactive controller uses the stochastic element to generate (spawn) a virtual object within the interactive wagering game. The process repeats, 934 to 946 for one or more times, generating (spawning) 936, 938, 940, 942, and 944, one or more virtual objects that the player is to interact with in a specified manner. The interactive controller determines 950 whether or not the player has interacted with the virtual objects in the specified manner. If so, the interactive controller determines 952 that the player has advanced to additional objectives (missions) through successful interaction in the specified manner.

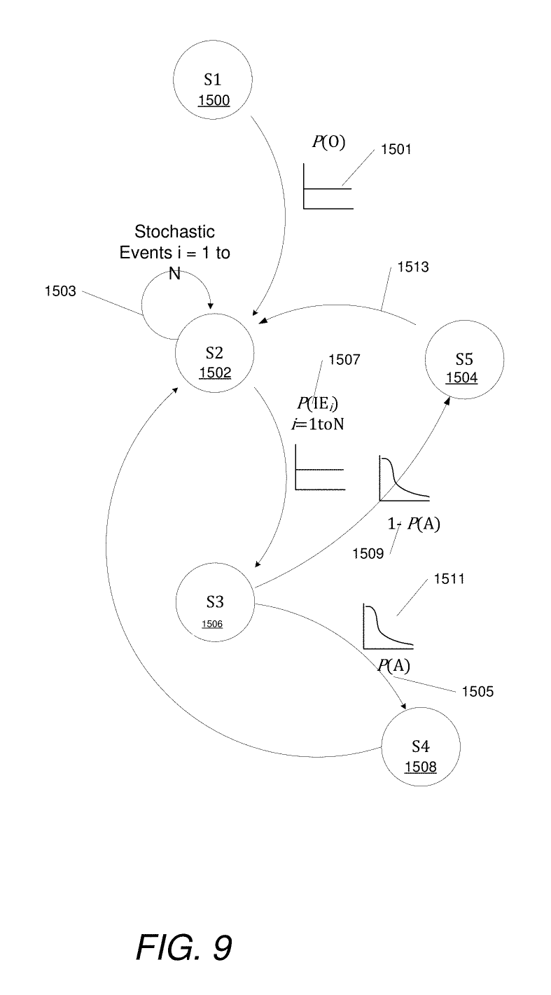

FIG. 9 is a state diagram illustrating a wagering process of an interactive wagering process system in accordance with various embodiments of the invention. At a state S1 1500 the interactive wagering process system generates a stochastic element of one or more objectives or missions, O, as described herein, accordingly the interactive wagering process system makes a stochastic transition 1501 to an objective state S2 1502 with a probability of P(O) to a particular objective will be generated. The objectives are objectives a player will attempt to achieve as the player interacts with an interactive application. In some embodiments, the interactive application is a skill-based game wherein a player interacts with the interactive application by playing the skill-based game.

In an example embodiment, the skill-based game is a two-dimensional infinite runner style game where during an interactive wagering process a player guides a virtual character through a series of stochastic elements in the form of virtual obstacles and attempts to interact with a plurality of stochastic elements in the form of virtual objects that the character can either interact with or collect as one or more objectives. Virtual contact or collision with one or more of the virtual obstacles will end the interactive wagering process and a wagering outcome is determined based on achievement of the one or more objectives.

In many embodiments, an objective includes traveling a specified virtual distance within a game world of the skill-based game.

In some embodiments, an objective includes collecting at least a specified number of specified virtual objects. These virtual objects may include, but are not limited to, virtual coins or other types of virtual currencies, and in-application objects that can be utilized by the player to enhance their skillful interactions within the skill-based game such a power-ups, special items or the like.

In various embodiments, an objective includes interacting with a specified virtual object or specified virtual obstacle in a specified manner.

While the interactive wagering process system is in state S2 1502, the player interacts with the interactive application attempting to achieve the one or more objectives. While attempting to achieve the one or more objectives, the player interacts with one or more interactive elements in the form of the virtual objects and virtual obstacles. The interactive elements are generated in accordance one or more stochastic elements in the form of stochastic components. Additional interactive elements are generated by the interactive wagering process system within the context of the interactive application as the player attempts to achieve the one or more objectives. The interactive wagering process system stochastically generates the interactive elements in one or more stochastic events; accordingly, each generation event can serve as a stochastic transition as indicated by stochastic transition 1503 having generation events i=1 to N, whereby the interactive wagering process system generates additional interactive elements in the interactive application the player while the player skillfully interacts with the skill-based game of the interactive application. Whether or not the interactive elements are generated in a stochastic event is in accordance with a probability P(IEi) 1507.

An objective may be associated with the generated interactive elements as achievement of the objective may include a player interacting with one or more specified interactive elements in a specified manner. Accordingly, if a specified interactive element of an objective is generated by the interactive wagering process system, the interactive wagering process system transitions to state S3 1506. While in state S3, the interactive wagering process system detects player interactions with the interactive elements to detect if the player has achieved the objective. If the interactive wagering process system detects that the player has successfully achieved the objective, the interactive wagering process system transitions to an achievement state S4 1508 as indicated by transition 1511 having a probability of P(A) 1505. If the interactive wagering process system determines that there are additional objectives yet to be achieved, the interactive wagering process system transitions back to state S2 and the player has additional opportunities to achieve additional objectives. If the interactive wagering process system detects that the player was unable to achieve the objective, as indicated by the probability 1−P(A) 1509, the interactive wagering process system stochastically transitions to a state S5 1504 in which the interactive wagering process system determines whether or not to continue the interactive wagering process. In some embodiments, if the interactive wagering process system detects that an objective was not achieved, the interactive wagering process is terminated. If the interactive wagering process system determines that the interactive wagering process is to continue, interactive wagering process system transitions 1513 to state S2 1502.

At an end of the interactive wagering process, one or more wagering outcomes are determined based on the detected achievements of one or more objectives.

In many embodiments, the probability that the interactive wagering process system will generate a specified interactive element of an objective is less than one, that is P(IEi)<1.0, while the probability that the player will be able to successfully interact with the interactive element to achieve the objective is high, that is P(A)⇒1.0. Accordingly, the probability that a player will receive an interactive element and be successful in using the interactive element to achieve the objective is primarily controlled by whether or not the interactive wagering process system generates the interactive resources that is the probability of the player achieving the objective is approximately P(IEi).

More specifically, in various embodiments where an objective has a plurality of interactive elements:

$$P ( Oi achieved ) = {\sum }_{k = s}^{n} ( \begin{matrix}n \\ k\end{matrix} ) {P ( IE )}^{k} {( 1 - P ( IE ) )}^{n - k}$$

Where:

P(Oi achieved)=probability that a player will have achieved an objective i, Oi.

n=number of generation events.

k=number of generations interactive elements.

s=number of generations of interactive element of the objective, Oi.

P(IE)=probability of interactive element being generated.

In an example embodiment, the skill-based game is a first person shooter, an objective to be achieved by the player is to shoot 12 virtual opponents with a virtual gun holding 6 virtual rounds. If the virtual gun is empty, the empty virtual gun may be used as a virtual club to defeat the virtual opponent. If the player fails to shoot or club a virtual opponent, the player loses the skill-based game. The player is to be provided fresh virtual guns in one or more stochastic generation events. In reference to the above equation, an interactive element is a fresh virtual gun, accordingly s, the number of stochastic generation events needed to complete the objective, is 2. At each stochastic generation event, the probability that a fresh virtual gun will be generated is 0.5. If the player survives long enough to get to only 1 stochastic generation event, the player has no chance to achieve the objective. If the player manages to get to 3 or more stochastic generation events, the player will have a high probability of getting enough fresh virtual guns to complete the objective of shooting 12 virtual opponents.

In some embodiments, an interactive application of an interactive controller implements a skill-based game that is provided to one or more players by an interactive controller. The interactive application generates a presentation of the skill-based game using procedurally generated stochastic elements in the form of interactive elements such as, but not limited to, in-application resources used by the player to play the skill-based game. In operation, a wagering process controller uses wagering process logic to generate one or more stochastic components a described herein. Data of the stochastic components are communicated to the interactive controller by the process controller as application resource data. The interactive controller receives the stochastic component data and the interactive application uses the stochastic component data to generate the in-application resources.

In various embodiments, in-application resources in the form of identifiers of virtual objects and/or virtual obstacles are stored in one or more lookup tables. The interactive application uses the identifiers to generate one or more in-application resources. The interactive controller uses the stochastic components as indexes into the lookup tables to determine one or more in-application identifiers and uses the one or more in-application identifiers to generate one or more in-application resources. In some embodiments, the stochastic component data are used as variables in conditional tests of the interactive application and the interactive application generates one or more in-application resources based on the outcome of the conditional tests.

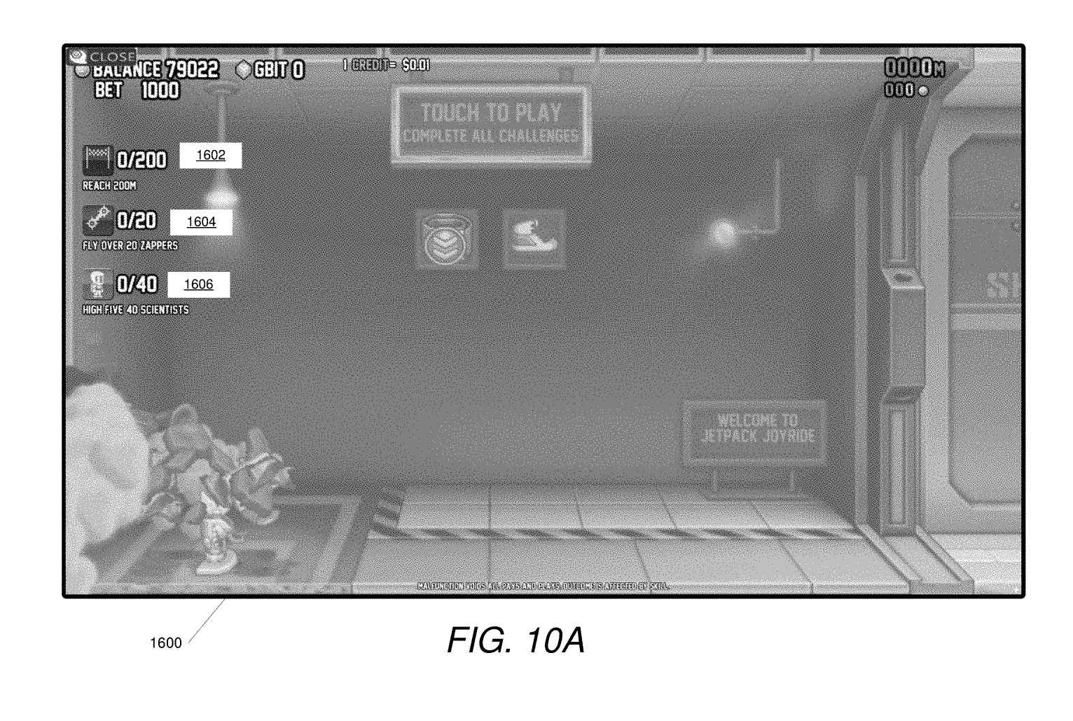

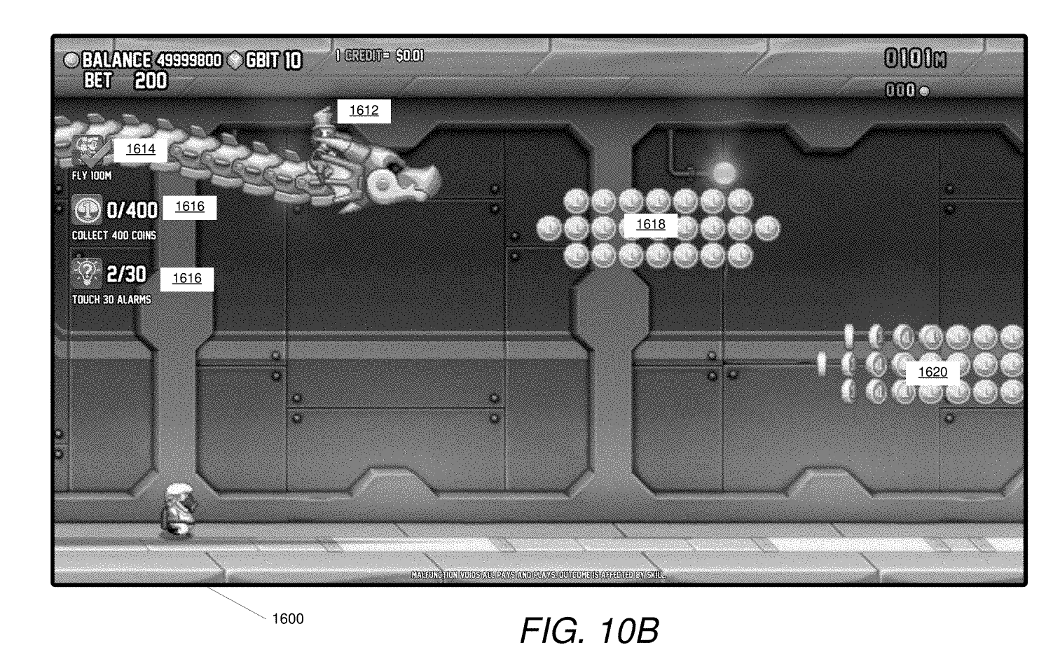

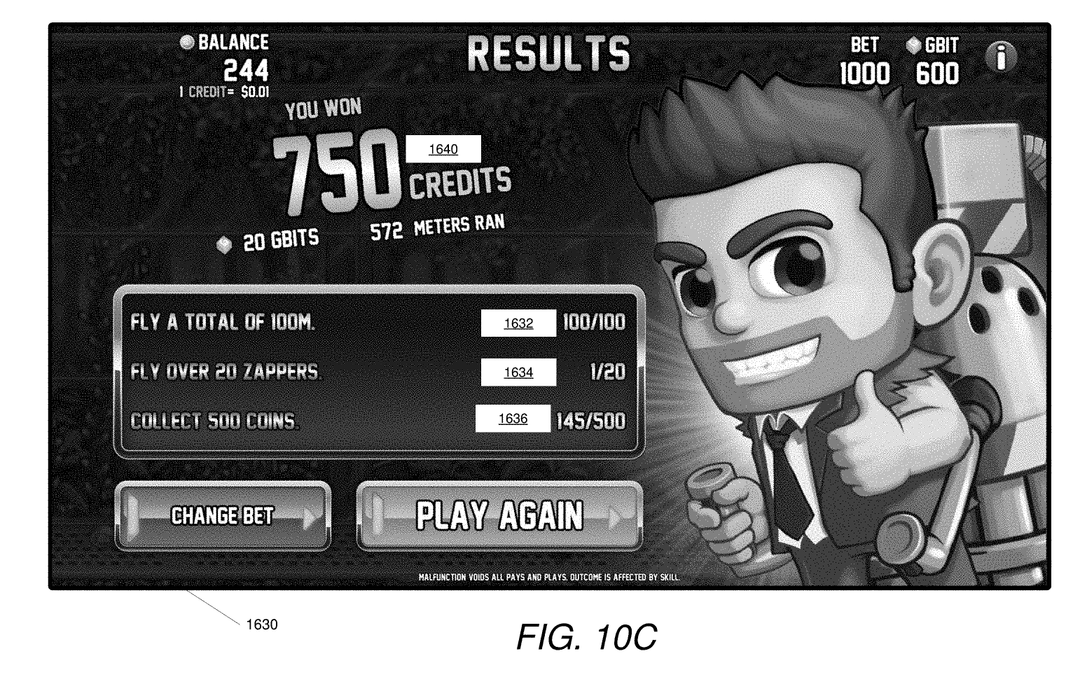

FIGS. 10A, 10B and 10C are illustrations of a user interface of an interactive wagering process system in accordance with various embodiments of the invention. In an example embodiment, the user interface is a presentation generated by an interactive application in form of a skill-based game. The skill-based game is a two-dimensional infinite runner style game where during an interactive wagering process a player guides a virtual character through a series of stochastic elements in the form of interactive elements that are virtual obstacles and attempts to interact with a plurality of stochastic elements in the form of interactive elements that are virtual objects that the character can either interact with or collect. Virtual contact or collision with one or more of the virtual obstacles will end the interactive wagering process and a wagering outcome is determined based on achievement of one or more objectives.

In many embodiments, an objective includes traveling a specified virtual distance within a game world of the skill-based game.

In some embodiments, an objective includes collecting at least a specified number of specified virtual objects. These virtual objects may include, but are not limited to, virtual coins or other types of virtual currencies, and in-application objects that can be utilized by the player to enhance their skillful interactions within the skill-based game such a power-ups, special items or the like.

In various embodiments, an objective includes interacting with a specified virtual object or specified virtual obstacle in a specified manner.

Referring now to FIG. 10A, a user interface 1600 includes a listing of one or more objectives (missions) that a player is to achieve while playing the interactive wagering game. A first objective is to travel a specified virtual distance 1602, namely “reach 200M”. A second objective is to interact with a specified number of virtual objects in a specified manner 1604, namely “fly over 20 zappers.” A third objective is to interact with a specified number of virtual objects in a specified manner 1606, namely “high five 40 scientists.”

Referring now to FIG. 10B, a user interface 1610 illustrates a player controlling a player character 1612 to interact with virtual objects in a specified manner. As illustrated, the player has traveled a specified virtual distance, that is flown 100M 1614. The player is attempting to interact with specified virtual objects in a specified manner, namely collect 400 coins 1616 and touch 30 alarms 1618. Also illustrated are virtual objects in the form of coins 1618 and 1620.

Referring now to FIG. 10C, the player has completed the game and user interface 1630 is displaying to the player what objectives were achieved by the player. As illustrated, the player has traveled a specified virtual distance, namely 100M of 100M 1632. The player has also made progress toward achieving an objective of interacting with a specified virtual object in a specified manner, namely the player flew over 1 of 20 zappers 1634, and the player collected 145 of 500 coins 1636. The player is awarded 750 credits 1640 for achieving the objective of flying 100 meters.

In many embodiments, an objective includes traveling a specified virtual distance within a game world of the skill-based game.

In some embodiments, an objective includes collecting at least a specified number of specified virtual objects. These virtual objects may include, but are not limited to, virtual coins or other types of virtual currencies, and in-application objects that can be utilized by the player to enhance their skillful interactions within the skill-based game such a power-ups, special items or the like.

In various embodiments, an objective includes interacting with a specified virtual object or specified virtual obstacle in a specified manner.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An interactive process wagering electronic gaming machine, comprising:
an interactive controller constructed to:
receive from a process controller a stochastic element;
generate a virtual object in an interactive wagering game using the stochastic element;
detect player interactions of a player with the player presentation;
determine if a player has interacted with the virtual object in a specified manner;
detect an objective achievement based on the player interactions and the virtual object; and
communicate the objective achievement to the wagering process controller; and
the wagering process controller operatively connected to the interactive controller, wherein the wagering process controller is constructed to:
generate a random number using a random number generator;
generate the stochastic element using the random number;
communicate the stochastic element to the interactive controller;
receive the objective achievement from the interactive controller;
determine an award to award to the player based on the objective achievement.

2. The interactive process wagering electronic gaming machine of claim 1, wherein the interactive controller and the wagering process controller are constructed from the same device.

3. The interactive process wagering electronic gaming machine of claim 1, wherein the wagering process controller is operatively connected to the interactive controller using a communication link.

4. The interactive process wagering electronic gaming machine of claim 1, wherein a credit processing subcontroller and the wagering process controller are constructed from the same device.

5. The interactive process wagering electronic gaming machine of claim 1, wherein a credit processing subcontroller, the interactive controller, and the wagering process controller are constructed from the same device.

6. The interactive process wagering electronic gaming machine of claim 1, further comprising:
a credit processing subcontroller; and
an enclosure constructed to mount:
a user input device operatively connected to the interactive controller;
a user output device operatively connected to the interactive controller;
a credit input device operatively connected to the credit processing subcontroller; and
a credit output device operatively connected to the credit processing subcontroller

7. The interactive process wagering electronic gaming machine of claim 6, wherein the wagering process controller is further constructed to:
communicate with the credit input device to receive a credit input;
credit a credit meter with credits based on the incoming credit data;
update the credit meter based on the objective achievement of the wager; and
communicate with the credit output device to generate a credit output based on credits transferred off of the credit meter.

8. An interactive process wagering electronic gaming machine, comprising:
an enclosure constructed to mount:
a user input device;
a user output device;
a credit input device;
a credit output device;
at least one processor operatively connected to the user input device, the user output device, the credit input device, and the credit output device; and
a memory operatively connected to the at least one processor, the memory storing processor executable instructions that when executed by the processor cause the processor to:
communicate with the credit input device to receive a credit input;
credit a credit meter with credits based on the credit data;
generate a random number using a random number generator;
generate a stochastic element using the random number;
generate a virtual object in an interactive wagering game using the stochastic element;
detect player interactions of a player with the player presentation;
determine if a player has interacted with the virtual object in a specified manner;
detect an objective achievement based on the player interactions and the virtual object;
update the credit meter based on the objective achievement; and
communicate with the credit output device to generate a credit output based on credits transferred off of the credit meter.
